(19) United States
(12) Patent Application Publication
(10) Pub. No.: US 2002/0158856 A1
(43) Pub. Date: Oct. 31, 2002

(54) Multi-stage sample position filtering

(76) Inventors: Michael F. Deering, Los Altos, CA (US); Karel Zikan, Seattle, WA (US)

Correspondence Address: Jeffrey C. Hood, Conley, Rose, & Tayon, P.C., P.O. Box 398, Austin, TX, 78767, US

(21) Appl. No.: 09/951,934

(22) Filed: Sep. 11, 2001

Related U.S. Application Data
(60) Provisional application No. 60/232,963, filed on Sep. 14, 2000.

(51) Int. Cl. G09G 5/00

(52) U.S. Cl. 345/204

(57) ABSTRACT

A system and method for rendering and displaying 3D objects. The system comprises a rendering unit coupled to a sample buffer and one or more convolve units. The rendering unit is configured to receive vertices of a triangle. The vertices are presented as coordinate pairs with respect to coordinate axes of a virtual screen space. The virtual screen space may be partitioned into bins. The rendering unit selects a set of candidate bins (i.e. bins which because of their positional relation to the triangle may contribute samples to the triangle), and generates a collection of sample positions within the candidate bins. Furthermore, the rendering unit (a) filters the sample positions to determine first filtered sample positions which reside inside a first tight bounding box having sides parallel to the coordinate axes, (b) filters the first filtered sample positions to determine second filtered sample positions which reside inside a second tight bounding box having sides of slope one and minus one with respect to the coordinate axes, (c) filters the second filtered sample positions with respect to the triangle edges to determine third filtered sample positions which reside inside the triangle, and (d) assigns sample values to the third filtered sample positions based on corresponding values assigned to the vertices of the triangle. The sample values are stored to the sample buffer. The one or more convolve units are configured to filter the sample values to generate a pixel value and transmit the pixel value to a display device.

### CROSS-REFERENCE TO RELATED APPLICATIONS

This application claims the benefit of U.S. Provisional Application No. 60/232,963 filed on Sep. 9, 2000 titled “Multi-stage Sample Position Filtering”.

### BACKGROUND OF THE INVENTION

1. Field of the Invention

This invention relates generally to the field of 3-D graphics and, more particularly, to a system and method for rendering and displaying 3-D graphical objects.

2. Description of the Related Art

Prior art graphics systems have typically partitioned objects into a stream of triangles. Each triangle may comprise three vertices with assigned color values. The triangles may be projected onto a two-dimensional screen space. A two-dimensional screen space may be populated with a two-dimensional array of positions (e.g. pixel positions). Array positions that fall within a given projected triangle are assigned color values based on spatial interpolation of the corresponding color values at the triangle vertices.

The process of filtering array positions to determine which positions fall within a given triangle may be referred to as triangle inclusion testing. Any improvement in the speed triangle inclusion testing is likely to have a direct impact on the cost and/or performance of graphics rendering systems and methods. Thus, there exists a substantial need for a system and method for improved triangle inclusion testing.

### SUMMARY OF THE INVENTION

A graphics system may, in one embodiment, comprise a rendering unit and a filtering unit (e.g. a convolve unit). The rendering unit may comprise one or more processors (e.g. DSP chips), dedicated hardware, or any combination thereof. The rendering unit may be configured to receive graphics data including three vertices defining a triangle. The vertices may be presented as coordinate pairs with respect to coordinate axes of a virtual screen space. The virtual screen space may be partitioned into bins. The rendering unit selects a set of candidate bins (i.e. bins which because of their positional relation to the triangle may contribute samples to the triangle), and generates a collection of sample positions within the candidate bins. The sample positions may be generated according to a perturbed regular sample-positioning scheme, a pseudo-random perturbed regular sample-positioning scheme, etc. Furthermore, the rendering unit:

(a) filters the sample positions to determine first filtered sample positions which reside inside a first tight bounding box having sides parallel to the coordinate axes,

(b) filters the first filtered sample positions to determine second filtered sample positions which reside inside a second tight bounding box having sides of slope one and minus one with respect to the coordinate axes,

(c) filters the second filtered sample positions with respect to the triangle edges to determine third filtered sample positions which reside inside the triangle, and

(d) assigns sample values to the third filtered sample positions based on corresponding values assigned to the vertices of the triangle.

The sample values may be stored in a sample buffer. The filtering unit may be configured read sample values from the sample buffer and to filter the sample values to generate a pixel value and transmit the pixel value to a display device.

In a second embodiment, a method for displaying graphical images comprises: filtering a collection of sample positions with respect to one or more tight bounding boxes which efficiently contain a given triangle. One of the tight bounding boxes may have side parallel to the coordinate axes of the ambient virtual screen space. Another of the tight bounding boxes may have sides with slope equal to one or minus one. The samples which fall within the one or more tight bounding boxes may be further filtered with respect to the edges of the triangle to determine those sample positions which fall inside the triangle. Filtering against the one or more tight bounding boxes may be performed rapidly (because such filtering does not require a multiplier) and reduces the number of sample positions which are supplied to the triangle edge-comparison computations which are more involved computationally (because they generally require a multiplication).

It is noted that the other tight bounding boxes are contemplated. For example, one of the tight bounding boxes may have sides of slope ½ and 2. A bit shifter may be used to implement the multiplications by ½ and 2 in performing edge comparisons on this bounding box. More generally, a tight bounding box may have sides of slope 2⁻ⁿ and 2ⁿ, where n is a positive integer.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates a computer system which includes a graphics system 112 for driving one or more display devices (including monitor devices and/or projection devices);

FIG. 2 is a simplified block diagram of the computer system of FIG. 1;

FIG. 3A is a block diagram illustrating one embodiment of a graphics board GB;

FIG. 3B is a block diagram illustrating one embodiment of a rendering unit comprised within graphics system 112;

FIG. 4 illustrates one embodiment of a “one sample per pixel” configuration for computation of pixel values;

FIG. 5A illustrates one embodiment of super-sampling;

FIG. 5B illustrates one embodiment of a random distribution of samples in a two-dimensional viewport;

FIG. 6 illustrates one embodiment for the flow of data through graphics board GB;

FIG. 7 illustrates another embodiment for the flow of data through graphics board GB;

FIG. 8 illustrates three different sample positioning schemes;

FIG. 9 illustrates one embodiment of a “perturbed regular” sample positioning scheme;

FIG. 10 illustrates another embodiment of the perturbed regular sample positioning scheme;

FIG. 11 illustrates one embodiment of a method for the parallel computation of pixel values from samples values;

FIG. 12A illustrates one embodiment for the traversal of a filter kernel 400 across a generic Column I of FIG. 11;

FIG. 12B illustrates one embodiment of a distorted traversal of filter kernel 400 across a generic Column I of FIG. 11;

FIGS. 13A and 13B illustrate one embodiment of a method for drawing samples into a super-sampled sample buffer;

FIG. 13C illustrates a triangle and an array of bins superimposed on a portion of a virtual screen space with a triangle bounding box minimally containing the triangle and a bin bounding box enclosing the triangle bounding box;

FIG. 13D illustrates an efficient subset of candidate bins containing a triangle in virtual screen space;

FIG. 13E illustrates a filtration of sample positions to determine second-stage sample positions which reside inside the triangle bounding box;

FIG. 13F illustrates another filtration of the second-stage sample positions to determine third-stage sample positions which reside inside a 45 degree bounding box;

FIG. 13G illustrates yet another filtration to determine which of the third-stage sample positions fall inside the triangle;

FIG. 14A illustrates one embodiment of an edge delta computation circuit 230 for computing horizontal and vertical edge displacements for each edge of a triangle;

FIG. 14B illustrates one embodiment for partitioning a coordinate space and coding the resulting regions referred to herein as octants;

FIG. 14C illustrates one embodiment of a feedback network 500 for computing the width and height of the triangle bounding box and for determining the controlling edge of the triangle;

FIG. 14D illustrates one embodiment of a method for determining triangle orientation based on a coded representation of edge displacements along two edges of the triangle;

FIG. 15 illustrates one embodiment of an ordinate value computation for a given triangle;

FIG. 16 illustrates one embodiment of a method for calculating pixel values from sample values; and

FIG. 17 illustrates details of one embodiment of a convolution for an example set of samples at a virtual pixel center in the 2-D viewport.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “connected” means “directly or indirectly connected”, and the term “coupled” means “directly or indirectly connected”.

### DETAILED DESCRIPTION OF SEVERAL EMBODIMENTS

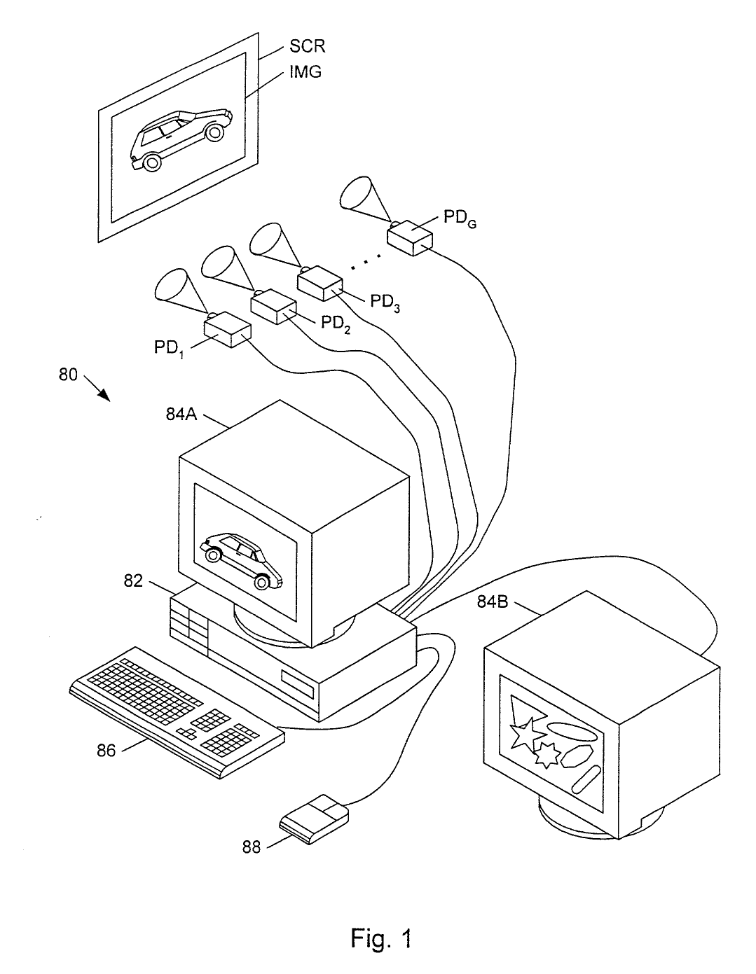

FIG. 1—Computer System

FIG. 1 illustrates one embodiment of a computer system 80, which performs three-dimensional (3-D) graphics. Computer system 80 comprises a system unit 82 which may couple to one or more display devices such as monitor devices 84A and 84B and/or projection devices PD₁ through PD_{G}. Monitor devices 84A and 84B may be based on any of a variety of display technologies. For example, monitor devices 84A and 84B may be CRT displays, LCD displays, gas-plasma displays, digital micro-mirror displays, liquid crystal on silicon (LCOS) display, etc., or any combination thereof. Similarly, projection devices PD₁ through PD_{G} may be realized by any of a variety of projection technologies. For example, projection devices PD₁ through PD_{G} may be CRT-based projectors, LCD projectors, LightValve projectors, gas-plasma projectors, digital micromirror (DMM) projectors, LCOS projectors, etc., or any combination thereof. Monitor devices 84A and 84B are meant to represent an arbitrary number of monitor devices.

Various input devices may be connected to system unit 82, including a keyboard 86, a mouse 88, a video camera, a trackball, a digitizing tablet, a six-degree of freedom input device, a head tracker, an eye tracker, a data glove, body sensors, a touch-sensitive screen, etc. Application software may be executed by computer system 80 to display 3-D graphical objects on projection screen SCR and/or monitor devices 84A and 84B. It is noted that projection devices PD₁ through PD_{G} may project their respective component images onto a surface other than a conventional projection screen, and/or onto surfaces that are curved (e.g. the retina of a human eye).

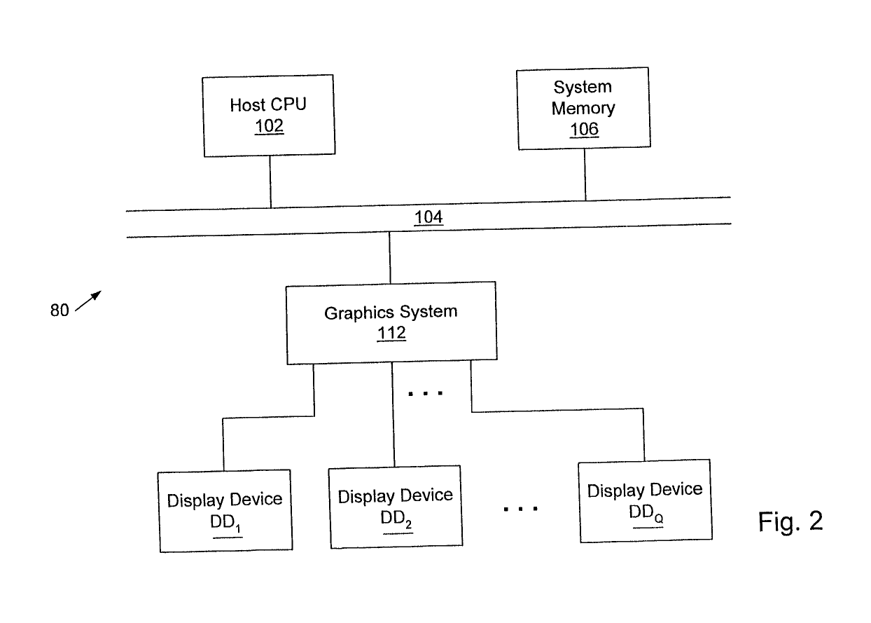

FIG. 2—Computer System Block Diagram

FIG. 2 presents a simplified block diagram for computer system 80. Computer system 80 comprises a host central processing unit (CPU) 102 and a 3-D graphics system 112 coupled to system bus 104. A system memory 106 may also be coupled to system bus 104. Other memory media devices such as disk drives, CD-ROM drives, tape drives, etc. may be coupled to system bus 104.

Host CPU 102 may be realized by any of a variety of processor technologies. For example, host CPU 102 may comprise one or more general purpose microprocessors, parallel processors, vector processors, digital signal processors, etc., or any combination thereof. System memory 106 may include one or more memory subsystems representing different types of memory technology. For example, system memory 106 may include read-only memory (ROM) and/or random access memory (RAM)—such as static random access memory (SRAM), synchronous dynamic random access memory (SDRAM) and/or Rambus dynamic access memory (RDRAM).

System bus 104 may comprise one or more communication buses or host computer buses (e.g., for communication between host processors and memory subsystems). In addition, various peripheral devices and peripheral buses may be connected to system bus 104.

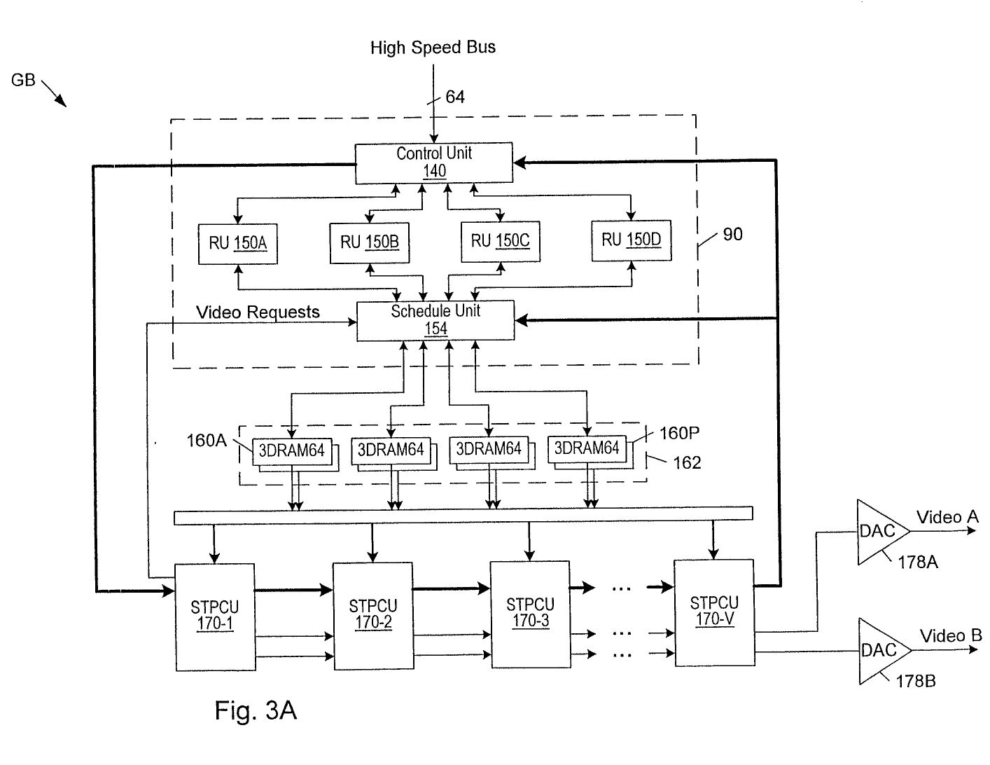

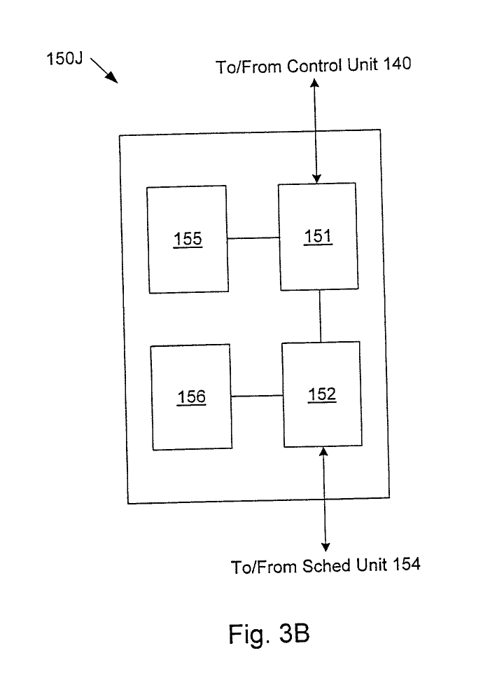

Graphics system 112 may comprise one or more graphics boards. The graphics boards may couple to system bus 104 by any of a variety of connectivity technologies (e.g. crossbar switches). The graphics boards may generate video signals for display devices DD₁ through DD_{Q} in response to graphics commands and data received from one or more graphics applications executing on host CPU 102. Display devices DD₁ through DD_{Q} may include monitor devices 84A and 84B, and projection device PD₁ through PD_{G}. FIG. 3A illustrates one embodiment of a graphics board GB for enhancing 3D-graphics performance.

Graphics board GB may couple to one or more busses of various types in addition to system bus 104. Furthermore, graphics board GB may couple to a communication port, and thereby, directly receive graphics data from an external source such as the Internet or a local area network.

Host CPU 102 may transfer information to/from graphics board GB according to a programmed input/output (I/O) protocol over system bus 104. Alternately, graphics board GB may access system memory 106 according to a direct memory access (DMA) protocol or through intelligent bus mastering.

A graphics application, e.g. an application conforming to an application programming interface (API) such as OpenGL® or Java® 3D, may execute on host CPU 102 and generate commands and data that define geometric primitives such as polygons for output on display devices DD₁ through DD_{Q}. Host CPU 102 may transfer this graphics data to system memory 106. Thereafter, the host CPU 102 may transfer the graphics data to graphics board GB over system bus 104. In another embodiment, graphics board GB may read geometry data arrays from system memory 106 using DMA access cycles. In yet another embodiment, graphics board GB may be coupled to system memory 106 through a direct port, such as an Advanced Graphics Port (AGP) promulgated by Intel Corporation.

Graphics board GB may receive graphics data from any of various sources including host CPU 102, system memory 106 or any other memory, external sources such as a network (e.g., the Internet) or a broadcast medium (e.g. television). While graphics board GB is described above as a part of computer system 80, graphics board GB may also be configured as a stand-alone device.

Graphics board GB may be comprised in any of various systems including a network PC, an Internet appliance, a game console, a virtual reality system, a CAD/CAM station, a simulator (e.g. an aircraft flight simulator), a television (e.g. an HDTV system or an interactive television system), or other devices which display 2D and/or 3D graphics.

As shown in FIG. 3A, graphics board GB may comprise a graphics processing unit (GPU) 90, a super-sampled sample buffer 162, and one or more sample-to-pixel calculation units 170-1 through 170-V. Graphics board GB may also comprise one or more digital-to-analog converters (DACs) 178A-B.

Graphics processing unit 90 may comprise any combination of processing technologies. For example, graphics processing unit 90 may comprise specialized graphics processors or calculation units, multimedia processors, DSPs, general-purpose processors, reconfigurable logic (e.g. programmable gate arrays), dedicated ASIC chips, etc.

In one embodiment, graphics processing unit 90 may comprise one or more rendering units 150A-D. Graphics processing unit 90 may also comprise one or more control units 140, and one or more schedule units 154. Sample buffer 162 may comprise one or more sample memories 160A-160P.

A. Control Unit 140

Control unit 140 operates as the interface between graphics board GB and CPU 102, i.e. controls the transfer of data between graphics board GB and CPU 102. In embodiments where rendering units 150A-D comprise two or more rendering units, control unit 140 may also divide a stream of graphics data received from CPU 102 and/or system memory 106 into a corresponding number of parallel streams that are routed to the individual rendering units.

The graphics data stream may be received from CPU 102 and/or system memory 106 in a compressed form. Graphics data compression may advantageously reduce the required transfer bandwidth for the graphics data stream. In one embodiment, control unit 140 may be configured to split and route the received data stream to rendering units 150A-D in compressed form.

The graphics data may comprise graphics primitives. As used herein, the term graphics primitive includes polygons, parametric surfaces, splines, NURBS (non-uniform rational B-splines), sub-division surfaces, fractals, volume primitives, and particle systems. These graphics primitives are described in detail in the textbook entitled “Computer Graphics: Principles and Practice” by James D. Foley, et al., published by Addison-Wesley Publishing Co., Inc., 1996.

It is noted that the embodiments and examples presented herein are described in terms of polygons (e.g. triangles) for the sake of simplicity. However, any type of graphics primitive may be used instead of or in addition to polygons in these embodiments and examples.

B. Rendering Units 150A-D

Each of rendering units 150A-D (also referred to herein as draw units) may receive a stream of graphics data from control unit 140, and perform a number of functions in response to the graphics stream. For example, each of rendering units 150A-D may be configured to perform decompression (if the received graphics data is presented in compressed form), transformation, clipping, lighting, texturing, depth cueing, transparency processing, setup, and virtual screen-space rendering of graphics primitives occurring within the graphics stream. Each of rendering units 15OA-D may comprise one or more processors (e.g. specialized graphics processors, digital signal processors, general purpose processors, etc.) and/or specialized circuitry (e.g. ASIC chips).

In one embodiment, each of rendering units 15OA-D may be configured in accord with rendering unit 150J illustrated in FIG. 3B. Rendering unit 150J may comprise a first rendering unit 151 and second rendering unit 152. First rendering unit 151 may be configured to perform decompression (for compressed graphics data), format conversion, transformation, lighting, etc. Second rendering unit 152 may be configured to perform setup computations, virtual screen space rasterization, sample rendering, etc. First rendering unit 151 may be coupled to first data memory 155, and second rendering unit 152 may be coupled to second data memory 156. First data memory 155 may comprise RDRAM, and second data memory 156 may comprise SDRAM. First rendering unit 151 may comprise one or more processors such as media processors. Second rendering unit 152 may comprise a dedicated ASIC chip.

Depending upon the type of compressed graphics data received, rendering units 150A-D may be configured to perform arithmetic decoding, run-length decoding, Huffman decoding, and dictionary decoding (e.g., LZ77, LZSS, LZ78, and LZW). Rendering units 150A-D may also be configured to decode graphics data that has been compressed using geometric compression. Geometric compression of 3D graphics data may achieve significant reductions in data size while retaining most of the image quality. A number of methods for compressing and decompressing 3D geometry are described in:

U.S. Pat. No. 5,793,371, U.S. application Ser. No. 08/511,294, filed on Aug. 4, 1995, entitled “Method And Apparatus For Geometric Compression Of Three-Dimensional Graphics Data,” Attorney Docket No. 5181-05900; and

U.S. patent application Ser. No. 09/095,777, filed on Jun. 11, 1998, entitled “Compression of Three-Dimensional Geometry Data Representing a Regularly Tiled Surface Portion of a Graphical Object,” Attorney Docket No. 5181-06602.

In embodiments of graphics board GB that support decompression, the graphics data received by a rendering unit (i.e. any of rendering units 150A-D) may be decompressed into one or more graphics “primitives” which may then be rendered. The term primitive refers to geometric components that define the shape of an object, e.g., points, lines, triangles, polygons, polyhedra, or free-form surfaces in three dimensions.

Rendering units 150A-D may be configured to perform transformation. Transformation refers to applying a geometric operation to a primitive or an object comprising a set of primitives. For example, an object represented by a set of vertices in a local coordinate system may be embedded with arbitrary position, orientation, and size in world space using an appropriate sequence of translation, rotation, and scaling transformations. Transformation may also comprise reflection, skewing, or any other affine transformation. More generally, transformations may comprise non-linear operations.

Rendering units 150A-D may be configured to perform lighting. Lighting refers to calculating the illumination of the objects. Lighting computations result in an assignment of color and/or brightness to objects or to selected points (e.g. vertices) on objects. Depending upon the shading algorithm being used (e.g., constant, Gouraud, or Phong shading), lighting may be evaluated at a number of different locations. For example, if constant shading is used (i.e., the lighted surface of a polygon is assigned a constant illumination value), then the lighting need only be calculated once per polygon. If Gouraud shading is used, then the lighting is calculated once per vertex. Phong shading calculates the lighting on a per-sample basis.

Rendering units 150A-D may be configured to perform clipping. Clipping refers to the elimination of primitives or portions of primitives, which lie outside a clipping region (e.g. a two-dimensional viewport rectangle). For example, the clipping of a triangle to the two-dimensional viewport may result in a polygon (i.e. the polygon which lies interior to the triangle and the rectangle). The resultant polygon may be fragmented into sub-primitives (e.g. triangles). In the preferred embodiment, only primitives (or portions of primitives) which survive the clipping computation are rendered in terms of samples.

Rendering units 150A-D may be configured to perform virtual screen space rendering. Virtual screen space rendering refers to calculations that are performed to generate samples for graphics primitives. For example, the vertices of a triangle in 3-D may be projected onto the 2-D viewport. The projected triangle may be populated with samples, and ordinate values (e.g. red, green, blue, alpha, Z, etc.) may be assigned to the samples based on the corresponding ordinates values already determined for the projected vertices. (For example, the red value for each sample in the projected triangle may be interpolated from the known red values of the vertices.) These sample ordinate values for the projected triangle may be stored in sample buffer 162. A virtual image accumulates in sample buffer 162 as successive primitives are rendered. Thus, the 2-D viewport is said to be a virtual screen on which the virtual image is rendered. The sample ordinate values comprising the virtual image are stored into sample buffer 162. Points in the 2-D viewport are described in terms of virtual screen coordinates X and Y, and are said to reside in virtual screen space.

When the virtual image is complete, e.g., when all graphics primitives have been rendered, sample-to-pixel calculation units 170 may access the samples comprising the virtual image, and may filter the samples to generate pixel ordinate values (e.g. red, green, blue, alpha, etc.). In other words, the sample-to-pixel calculation units 170 may perform a spatial convolution of the virtual image with respect to a convolution kernel C(X,Y) to generate pixel ordinate values. For example, a sample-to-pixel calculation unit may compute a red value Rₚ for a pixel P at any location (Xₚ,Yₚ) in virtual screen space based on the relation

$${R}_{p} = \frac{1}{E} \sum C ( {X}_{i} - {X}_{p} , {Y}_{i} - {Y}_{p} ) R ( {X}_{i} , {Y}_{i} ) ,$$

where the summation is evaluated at sample positions (Xᵢ,Yᵢ) in a neighborhood of location (Xₚ, Yₚ), and where R(Xᵢ, Yᵢ) are the red values corresponding to sample positions (Xᵢ, Yᵢ). Since convolution kernel C(X,Y) may be non-zero only in a neighborhood of the origin, the displaced kernel C(X−Xₚ, Y−Yₚ) may take non-zero values only in a neighborhood of location (Xₚ, Yₚ). Similar summations to compute other pixel ordinate values (e.g. green, blue, alpha, etc.) in terms of the corresponding sample ordinate values may be performed. In the preferred embodiment, some or all of the pixel ordinate value summations may be performed in parallel.

The value E is a normalization value that may be computed according to the relation

E=υC(Xₗ−Xₚ, Yₗ−Yₚ),

where the summation is evaluated for the same samples (Xᵢ,Yᵢ) as in the red pixel value summation above. The summation for the normalization value E may be performed in parallel with the red, green, blue, and/or alpha pixel value summations. The location (Xₚ, Yₚ) may be referred to as a pixel center, or a pixel origin. The pixel ordinate values (e.g. RGB) may be presented to one or more of display devices DD₁ through DD_{Q}.

In the embodiment of graphics board GB shown in FIG. 3A, rendering units 150A-D compute sample values instead of pixel values. This allows rendering units 150A-D to perform super-sampling, i.e. to compute more than one sample per pixel. Super-sampling is discussed more thoroughly below. More details on super-sampling are discussed in the following books:

“Principles of Digital Image Synthesis” by Andrew S. Glassner, 1995, Morgan Kaufman Publishing (Volume 1);

“The Renderman Companion” by Steve Upstill, 1990, Addison Wesley Publishing; and

“Advanced Renderman: Creating Cgi for Motion Pictures (Computer Graphics and Geometric Modeling)” by Anthony A. Apodaca and Larry Gritz, Morgan Kaufmann Publishers, c1999, ISBN: 1558606181.

Sample buffer 162 may be double-buffered so that rendering units 150A-D may write samples for a first virtual image into a first portion of sample buffer 162, while a second virtual image is simultaneously read from a second portion of sample buffer 162 by sample-to-pixel calculation units 170.

It is noted that the 2-D viewport and the virtual image, which is rendered with samples into sample buffer 162, may correspond to an area larger than the area which is physically displayed via display devices DD₁ through DD_{Q}. For example, the 2-D viewport may include a viewable subwindow. The viewable subwindow may represent displayable graphics information, while the marginal area of the 2-D viewport (outside the viewable subwindow) may allow for various effects such as panning and zooming. In other words, only that portion of the virtual image which lies within the viewable subwindow gets physically displayed. In one embodiment, the viewable subwindow equals the whole of the 2-D viewport. In this case, all of the virtual image gets physically displayed.

C. Data Memories

In some embodiments, each of rendering units 150A-D may be configured with two memories similar to rendering unit 150J of FIG. 3B. First memory 155 may store data and instructions for rendering unit 151. Second memory 156 may store data and/or instructions for second rendering unit 152. While implementations may vary, in one embodiment memories 155 and 156 may comprise two 8 MByte SDRAMs providing 16 MBytes of storage for each rendering unit 150A-D. Memories 155 and 156 may also comprise RDRAMs (Rambus DRAMs). In one embodiment, RDRAMs may be used to support the decompression and setup operations of each rendering unit, while SDRAMs may be used to support the draw functions of each rendering unit.

D. Schedule Unit

Schedule unit 154 may be coupled between rendering units 150A-D and sample memories 160A-P. Schedule unit 154 is configured to sequence the completed samples and store them in sample memories 160A-P. Note in larger configurations, multiple schedule units 154 may be used in parallel. In one embodiment, schedule unit 154 may be implemented as a crossbar switch.

E. Sample Memories

Super-sampled sample buffer 162 comprises sample memories 160A-P, which are configured to store the plurality of samples generated by rendering units 150A-D. As used herein, the term “sample buffer” refers to one or more memories which store samples. As previously noted, samples may be filtered to form each pixel ordinate value. Pixel ordinate values may be provided to one or more of display devices DD₁ through DD_{Q}. Sample buffer 162 may be configured to support super-sampling, critical sampling, or sub-sampling with respect to pixel resolution. In other words, the average distance between adjacent samples in the virtual image (stored in sample buffer 162) may be smaller than, equal to, or larger than the average distance between adjacent pixel centers in virtual screen space. Furthermore, because the convolution kernel C(X,Y) may take non-zero functional values over a neighborhood which spans several pixel centers, a single sample may contribute to several pixels.

Sample memories 160A-P may comprise any of various types of memories (e.g., SDRAMs, SRAMs, RDRAMs, 3 DRAMs, or next-generation 3 DRAMs) in varying sizes. In one embodiment, each schedule unit 154 is coupled to four banks of sample memories, where each bank comprises four 3 DRAM-64 memories. Together, the 3 DRAM-64 memories may form a 116-bit deep super-sampled sample buffer that stores multiple samples per pixel. For example, in one embodiment, each of sample memories 160A-P may store up to sixteen samples per pixel.

3 DRAM-64 memories are specialized memories configured to support full internal double buffering with single-buffered Z in one chip. The double-buffered portion comprises two RGBX buffers, where X is a fourth channel that can be used to store other information (e.g., alpha). 3 DRAM-64 memories also have a lookup table that takes in window ID information and controls an internal 2-1 or 3-1 multiplexor that selects which buffer's contents will be output. 3 DRAM-64 memories are next-generation 3 DRAM memories that may soon be available from Mitsubishi Electric Corporation's Semiconductor Group. In one embodiment, 32 chips used in combination are sufficient to create a double-buffered 1280×1024 super-sampled sample buffer with eight samples per pixel.

Since the 3 DRAM-64 memories are internally double-buffered, the input pins for each of the two frame buffers in the double-buffered system are time multiplexed (using multiplexors within the memories). The output pins may be similarly time multiplexed. This allows reduced pin count while still providing the benefits of double buffering. 3 DRAM-64 memories further reduce pin count by not having Z output pins. Since Z comparison and memory buffer selection are dealt with internally, use of the 3 DRAM-64 memories may simplify the configuration of sample buffer 162. For example, sample buffer 162 may require little or no selection logic on the output side of the 3 DRAM-64 memories. The 3 DRAM-64 memories also reduce memory bandwidth since information may be written into a 3 DRAM-64 memory without the traditional process of reading data out, performing a Z comparison, and then writing data back in. Instead, the data may be simply written into the 3 DRAM-64 memory, with the memory performing the steps described above internally.

Each of rendering units 150A-D may be configured to generate a plurality of sample positions according to one or more sample positioning schemes. For example, in one embodiment, samples may be positioned on a regular grid. In another embodiment, samples may be positioned based on perturbations (i.e. displacements) from a regular grid. This perturbed-regular grid-positioning scheme may generate random sample positions if the perturbations are random or pseudo-random values. In yet another embodiment, samples may be randomly positioned according to any of a variety of methods for generating random number sequences.

The sample positions (or offsets that are added to regular grid positions to form the sample positions) may be read from a sample position memory (e.g., a RAM/ROM table). Upon receiving a polygon that is to be rendered, a rendering unit may determine which samples fall within the polygon based upon the sample positions. The rendering unit may render the samples that fall within the polygon, i.e. interpolate ordinate values (e.g. color values, alpha, depth, etc.) for the samples based on the corresponding ordinate values already determined for the vertices of the polygon. The rendering unit may then store the rendered samples in sample buffer 162. Note as used herein the terms render and draw are used interchangeably and refer to calculating ordinate values for samples.

F. Sample-to-pixel Calculation Units

Sample-to-pixel calculation units 170-1 through 170-V (collectively referred to as sample-to-pixel calculation units 170) may be coupled between sample memories 160A-P and DACs 178A-B. Sample-to-pixel calculation units 170 are configured to read selected samples from sample memories 160A-P and then perform a filtering operation (e.g. a convolution) on the samples to generate the output pixel values which are provided to one or more of DACs 178A-B. Sample-to-pixel calculation units 170 may be programmable to perform different filter functions at different times depending upon the type of output desired.

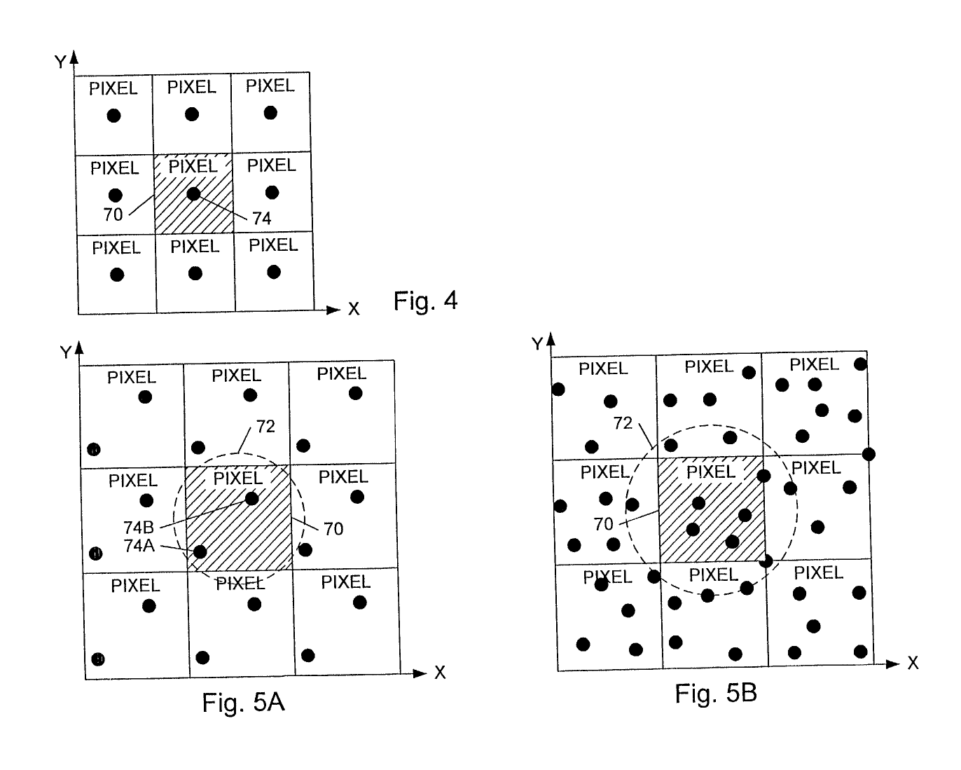

In one embodiment, sample-to-pixel calculation units 170 may implement a super-sample reconstruction band-pass filter to convert the super-sampled sample buffer data (stored in sample memories 160A-P) to pixel values. The support of the band-pass filter may cover a rectangular area in virtual screen space which is Lₚ pixels high and Wₚ pixels wide. Thus, the number of samples covered by the band-pass filter is approximately equal to HₚWₚS, where S is the number of samples per pixel. A variety of values for Lₚ, Wₚ and S are contemplated. For example, in one embodiment of the band-pass filter Lₚ=Wₚ=5. It is noted that with certain sample positioning schemes (see the discussion attending FIGS. 4, 5A & 5B), the number of samples that fall within the filter support may vary as the filter center (i.e. pixel center) is moved in the virtual screen space.

In other embodiments, sample-to-pixel calculation units 170 may filter a selected number of samples to calculate an output pixel. The selected samples may be multiplied by a spatial weighting function that gives weights to samples based on their position with respect to the center of the pixel being calculated.

The filtering operations performed by sample-to-pixel calculation units 170 may use any of a variety of filters. For example, the filtering operations may comprise convolution with a box filter, a tent filter, a cylindrical filter, a cone filter, a Gaussian filter, a Catmull-Rom filter, a Mitchell-Netravali filter, a windowed sinc filter, etc., or any combination thereof. Furthermore, the support of the filters used by sample-to-pixel calculation units 170 may be circular, elliptical, rectangular (e.g. square), triangular, hexagonal, etc.

Sample-to-pixel calculation units 170 may also be configured with one or more of the following features: color look-up using pseudo color tables, direct color, inverse gamma correction, and conversion of pixels to non-linear light space. Other features of sample-to-pixel calculation units 170 may include programmable video timing generators, programmable pixel clock synthesizers, cursor generators, and crossbar functions.

Once the sample-to-pixel calculation units 170 have computed color values for pixels, e.g. pixels in a scan line, the pixels may output to one or more video output channels through DACs 178A-B.

G. Digital-to-analog Converters

Digital-to-Analog Converters (DACs) 178A-B, collectively referred to as DACs 178, operate as the final output stage of graphics board GB. DACs 178 translate digital pixel data received from sample-to-pixel calculation units 170 into analog video signals. DAC 178A couples to output video channel A, and DAC 178B couples to output video channel B. DAC 178A may receive a first stream of digital pixel data from one or more of sample-to-pixel calculation units 170, and converts the first stream into a first video signal which is asserted onto output video channel A. Similarly, DAC 178B may receive a second stream of digital pixel data from one or more of sample-to-pixel calculation units 170, and converts the second stream into a second video signal which is asserted onto output video channel B.

In the preferred embodiment, sample-to-pixel calculation units 170 provide pixel values to DACs 178 without an intervening frame buffer. However, in one alternate embodiment, sample-to-pixel calculation units 170 output the pixel values to a frame buffer prior to display.

In one embodiment, some or all of DACs 178 may be bypassed or omitted in order to output digital pixel data in lieu of analog video signals. This may be useful where some or all of display devices DD₁ through DD_{Q} are based on a digital technology (e.g., an LCD-type display, an LCOS display, or a digital micro-mirror display).

In the preferred embodiment, multiple graphics boards may be chained together so that they share the effort of generating video data for a display device. Thus, in the preferred embodiment, graphics board GB includes a first interface for receiving one or more digital video streams from any previous graphics board in the chain, and a second interface for transmitting digital video streams to any subsequent graphics board in the chain.

It is noted that various embodiments of graphics board GB are contemplated with varying numbers of rendering units, schedule units, sample-to-pixel calculation units, sample memories, more or less than two DACs, more or less than two video output channels, etc.

FIGS. 4, 5A, 5B—Super-Sampling

FIG. 4 illustrates a portion of virtual screen space in a non-super-sampled embodiment of graphics board GB. The dots denote sample locations, and the rectangular boxes superimposed on virtual screen space indicate the boundaries between pixels. Rendering units 15OA-D may be configured to position one sample in the center of each pixel, and to compute values of red, green, blue, Z, etc. for the samples. For example, sample 74 is assigned to the center of pixel 70. Although rendering units 150A-D may compute values for only one sample per pixel, sample-to-pixel calculation units 170 may compute output pixel values based on multiple samples, e.g. by using a convolution filter whose support spans several pixels.

Turning now to FIG. 5A, an example of one embodiment of super-sampling is illustrated. In this embodiment, rendering units 150A-D compute two samples per pixel. The samples are distributed according to a regular grid. Even though there are more samples than pixels in FIG. 5A, sample-to-pixel calculation units 170 could compute output pixel values using one sample per pixel, e.g. by throwing out all but the sample nearest to the center of each pixel. However, a number of advantages arise from computing pixel values based on multiple samples.

A support region 72 is superimposed over pixel 70, and illustrates the support of a filter which is localized at pixel 70. The support of a filter is the set of locations over which the filter (i.e. the filter kernel) takes non-zero values. In this example, the support region 72 is a circular disc. A sample-to-pixel calculation unit may perform a filtering operation using any of a variety of filters which have region 72 as their support region. Thus, the sample-to-pixel calculation unit may compute the output pixel values (e.g. red, green, blue and Z values) for pixel 70 based only on samples 74A and 74B, because these are the only samples which fall within region 72. This filtering operation may advantageously improve the realism of a displayed image by smoothing abrupt edges in the displayed image (i.e., by performing anti-aliasing). The filtering operation may simply average the values of samples 74A-B to form the corresponding output values of pixel 70. More generally, the filtering operation may generate a weighted sum of the values of samples 74A-B, where the contribution of each sample is weighted according to some function of the sample's position (or distance) with respect to the center of pixel 70. The filter, and thus support region 72, may be repositioned for each output pixel being calculated. In other words, the filter center may visit the center of each output pixel for which pixel values are to be computed. Other filters and filter positioning schemes are also possible and contemplated.

In the example of FIG. 5A, there are two samples per pixel. In general, however, there is no requirement that the number of samples be related to the number of pixels. The number of samples may be completely independent of the number of pixels. For example, the number of samples may be smaller than the number of pixels. (This is the condition that defines sub-sampling).

Turning now to FIG. 5B, another embodiment of super-sampling is illustrated. In this embodiment, the samples are positioned randomly. Thus, the number of samples used to calculate output pixel values may vary from pixel to pixel. Rendering units 150A-D calculate color information at each sample position.

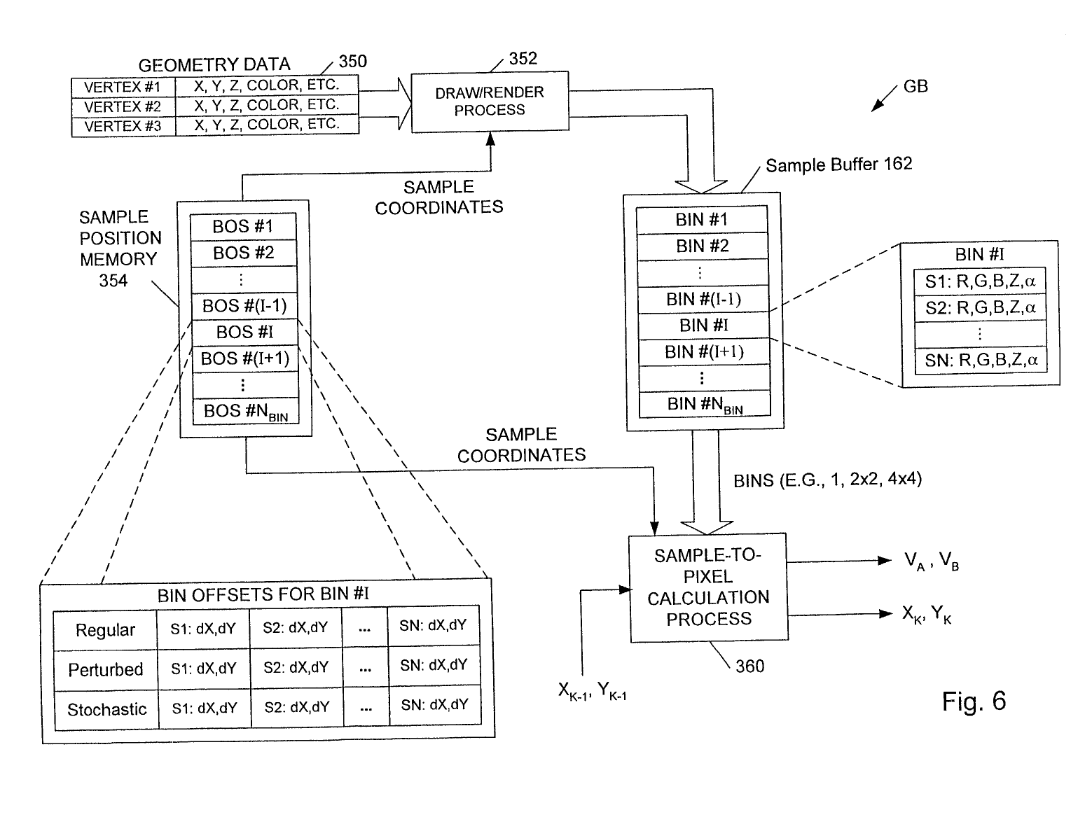

FIGS. 6-13—Super-sampled Sample Buffer with Real-time Convolution

FIG. 6 illustrates one embodiment for the flow of data through one embodiment of graphics board GB. As the figure shows, geometry data 350 is received by graphics board GB and used to perform draw process 352. The draw process 352 is implemented by graphics processing unit 90, i.e. by one or more of control unit 140, rendering units 150A-D, and schedule unit 154. Geometry data 350 comprises data for one or more polygons. Each polygon comprises a plurality of vertices (e.g., three vertices in the case of a triangle), some of which may be shared among multiple polygons. Data such as x, y, and Z coordinates, color data, lighting data and texture map information may be included for each vertex.

In addition to the vertex data, draw process 352 (which may be performed by each of rendering units 150A-D) also receives sample position information from a sample position memory 354. The sample position information defines the location of samples in virtual screen space, i.e. in the 2-D viewport. Draw process 352 selects the samples that fall within the polygon currently being rendered, calculates a set of ordinate values (e.g. red, green, blue, Z, alpha, and/or depth of field information) for each of these samples based on their respective positions within the polygon. For example, the Z value of a sample that falls within a triangle may be interpolated from the known Z values of the three vertices. Each set of computed sample ordinate values may be stored into sample buffer 162.

In one embodiment, sample position memory 354 may be embodied within rendering units 150A-D. In another embodiment, sample position memory 354 may be realized as part of as a separate memory, external to rendering units 150A-D.

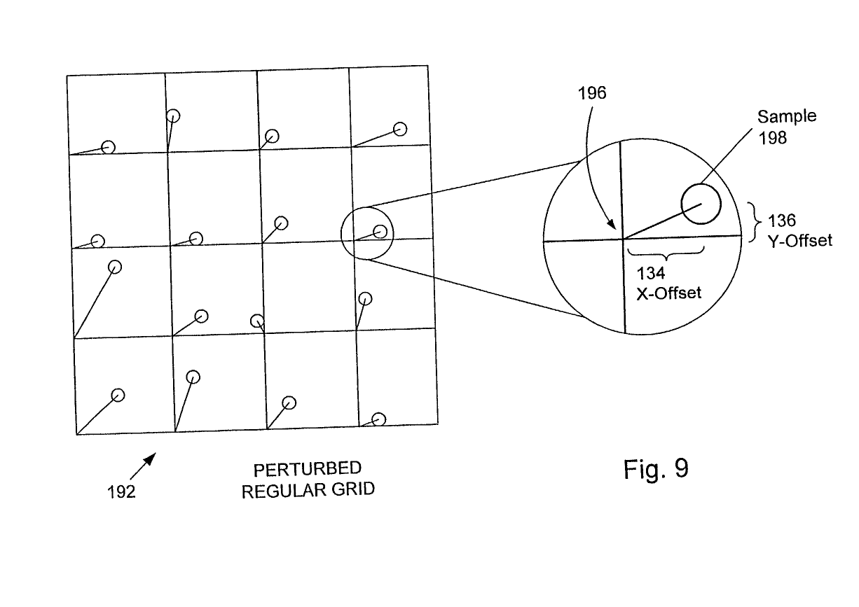

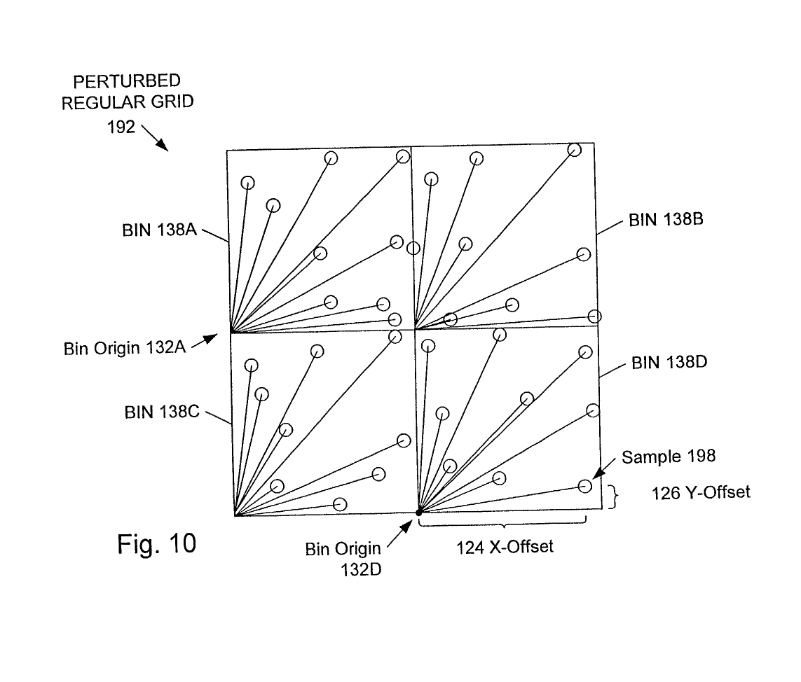

Sample position memory 354 may store sample positions in terms of their virtual screen coordinates (X,Y). Alternatively, sample position memory 354 may be configured to store only offsets dX and dY for the samples with respect to positions on a regular grid. Storing only the offsets may use less storage space than storing the entire coordinates (X, Y) for each sample. A dedicated sample position unit (not shown) may read and process the sample position information stored in sample position memory 354 to generate sample positions. More detailed information on the computation of sample positions is included below (see description of FIGS. 9 and 10).

In another embodiment, sample position memory 354 may be configured to store a table of random numbers. Sample position memory 354 may also comprise dedicated hardware to generate one or more different types of regular grids. This hardware may be programmable. The stored random numbers may be added as offsets to the regular grid positions generated by the hardware. In one embodiment, sample position memory 354 may be programmable to access or “unfold” the random number table in a number of different ways, and thus, may deliver more apparent randomness for a given length of the random number table. Thus, a smaller table may be used without generating the visual artifacts caused by simple repetition of sample position offsets.

Sample-to-pixel calculation process 360 uses the same sample positions as draw process 352. Thus, in one embodiment, sample position memory 354 may generate a sequence of random offsets to compute sample positions for draw process 352, and may subsequently regenerate the same sequence of random offsets to compute the same sample positions for sample-to-pixel calculation process 360. In other words, the unfolding of the random number table may be repeatable. Thus, it may not be necessary to store sample positions at the time of their generation for draw process 352.

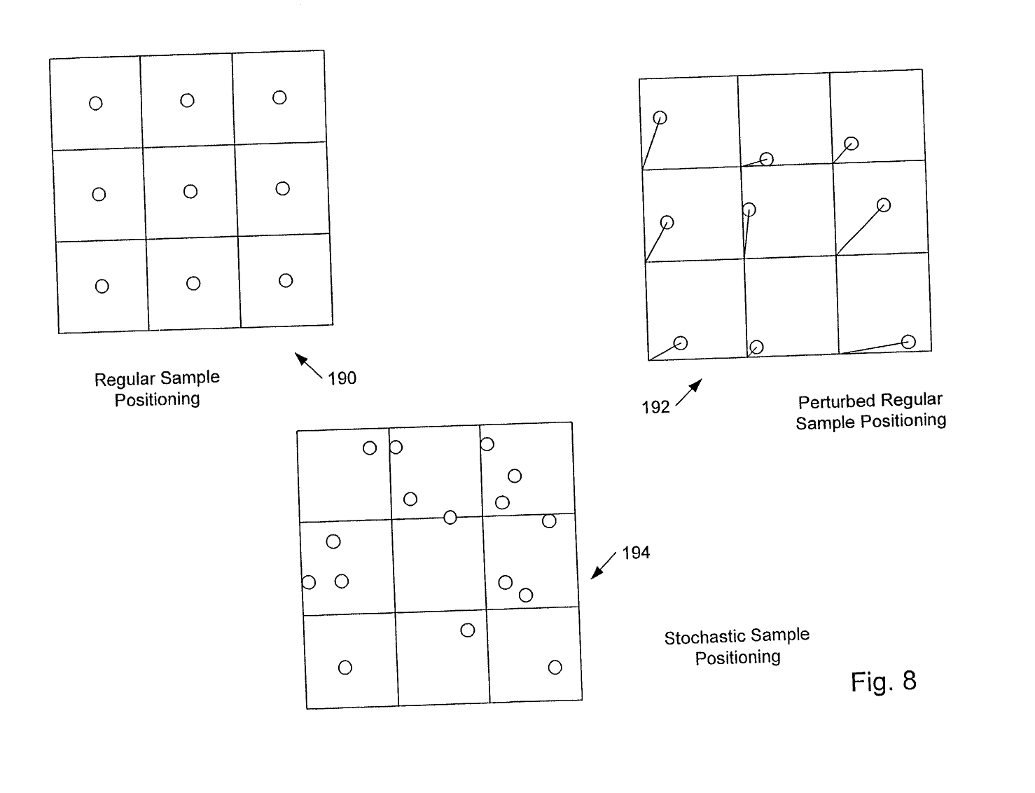

As shown in FIG. 6, sample position memory 354 may be configured to generate sample offsets according to a number of different sample-positioning schemes such as a regular grid scheme, a perturbed-regular grid scheme, or a random (i.e. stochastic) positioning scheme. Graphics board GB may receive an indication from the host operating system, device driver, or the geometry data 350 that indicates which type of sample positioning scheme is to be used. Thus, sample position memory 354 is configurable or programmable to generate sample position information according to one or more different schemes. More detailed information on several sample-positioning schemes is provided below. See description of FIG. 8.

In one embodiment, sample position memory 354 may comprise a RAM/ROM that contains stochastically determined sample points or sample offsets. Thus, the density of samples in virtual screen space may not be uniform when observed at small scale. Two bins with equal area centered at different locations in virtual screen space may contain different numbers of samples. As used herein, the term “bin” refers to a region or area in virtual screen space.

An array of bins may be superimposed over virtual screen space, i.e. the 2-D viewport, and the storage of samples in sample buffer 162 may be organized in terms of bins. Sample buffer 162 may comprise an array of memory blocks which correspond to the bins. Each memory block may store the sample ordinate values (e.g. red, green, blue, Z, alpha, etc.) for the samples that fall within the corresponding bin. The approximate location of a sample is given by the bin in which it resides. The memory blocks may have addresses which are easily computable from the corresponding bin locations in virtual screen space, and vice versa. Thus, the use of bins may simplify the storage and access of sample values in sample buffer 162.

Suppose (for the sake of discussion) that the 2-D viewport ranges from (0000,0000) to (FFFF,FFFF) in hexadecimal virtual screen coordinates. This 2-D viewport may be overlaid with a rectangular array of bins whose lower-left corners reside at the locations (XX00,YY00) where XX and YY independently run from 0×00 to 0×FF. Thus, there are 256 bins in each of the vertical and horizontal directions with each bin spanning a square in virtual screen space with side length of 256. Suppose that each memory block is configured to store sample ordinate values for up to 16 samples, and that the set of sample ordinate values for each sample comprises 4 bytes. In this case, the address of the memory block corresponding to the bin located at (XX00,YY00) may be simply computed by the relation BinAddr=(XX+YY*256)*16*4. For example, the sample S=(1C3B, 23A7) resides in the bin located at (1C00,2300). The set of ordinate values for sample S is then stored in the memory block residing at address 0×8C700=(0×231C)(0×40) in sample buffer 162. The number of bins and numerical ranges given in this example are not meant to be limiting.

The bins may tile the 2-D viewport in a regular array, e.g. in a square array, rectangular array, triangular array, hexagonal array, etc., or in an irregular array. Bins may occur in a variety of sizes and shapes. The sizes and shapes may be programmable. The maximum number of samples that may populate a bin is determined by the storage space allocated to the corresponding memory block. This maximum number of samples is referred to herein as the bin sample capacity, or simply, the bin capacity. The bin capacity may take any of a variety of values. The bin capacity value may be programmable. Henceforth, the spatial bins in virtual screen space and their corresponding memory blocks may be referred to simply as “bins”. The context will determine whether a memory bin or a spatial bin is being referred to.

The specific position of each sample within a bin may be determined by looking up the sample's offset in the RAM/ROM table, i.e., the sample's offset with respect to the bin position (e.g. the lower-left corner or center of the bin, etc.). However, depending upon the implementation, not all choices for the bin capacity may have a unique set of offsets stored in the RAM/ROM table. Offsets for a first bin capacity value may be determined by accessing a subset of the offsets stored for a second larger bin capacity value. In one embodiment, each bin capacity value supports at least four different sample-positioning schemes. The use of different sample positioning schemes may reduce final image artifacts that would arise in a scheme of naively repeating sample positions.

In one embodiment, sample position memory 354 may store pairs of 8-bit numbers, each pair comprising an x-offset and a y-offset. (Other offsets are also possible, e.g., a time offset, a Z-offset, etc.) When added to a bin position, each pair defines a particular position in virtual screen space, i.e. the 2-D viewport. To improve read access times, sample position memory 354 may be constructed in a wide/parallel manner so as to allow the memory to output more than one sample position per read cycle.

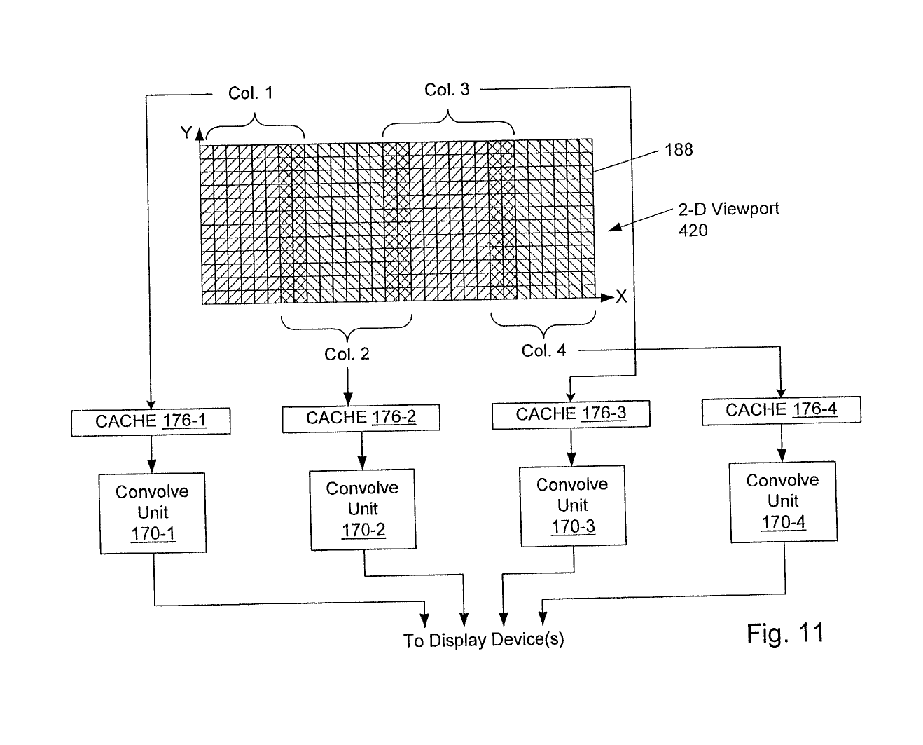

Once the sample positions have been read from sample position memory 354, draw process 352 selects the samples that fall within the polygon currently being rendered. Draw process 352 then calculates ordinate values (e.g. color values, Z, alpha, depth of field, etc.) for each of these samples and stores the data into sample buffer 162. In one embodiment, sample buffer 162 may only single-buffer Z values (and perhaps alpha values) while double-buffering other sample ordinates such as color. Unlike prior art systems, graphics system 112 may use double-buffering for all samples (although not all components of samples may be double-buffered, i.e., the samples may have some components that are not double-buffered). In one embodiment, the samples are stored into sample buffer 162 in bins. In some embodiments, the bin capacity may vary from frame to frame. In addition, the bin capacity may vary spatially for bins within a single frame rendered into sample buffer 162. For example, bins on the edge of the 2-D viewport may have a smaller bin capacity than bins corresponding to the center of the 2-D viewport. Since viewers are likely to focus their attention mostly on the center of the screen SCR, more processing bandwidth may be dedicated to providing enhanced image quality in the center of 2-D viewport. Note that the size and shape of bins may also vary from region to region, or from frame to frame. The use of bins will be described in greater detail below in connection with FIG. 11.

In parallel with draw process 352, filter process 360 is configured to: (a) read sample positions from sample position memory 354, (b) read corresponding sample values from sample buffer 162, (c) filter the sample values, and (d) output the resulting output pixel values onto video channels A and/or B. Sample-to-pixel calculation units 170 implement filter process 360. Filter process 360 is operable to generate the red, green, and blue values for an output pixel based on a spatial filtering of the corresponding data for a selected plurality of samples, e.g. samples falling in a neighborhood of the pixel center. Other values such as alpha may also be generated. In one embodiment, filter process 360 is configured to: (i) determine the distance of each sample from the pixel center; (ii) multiply each sample's ordinate values (e.g., red, green, blue, alpha) by a filter weight that is a specific (programmable) function of the sample's distance; (iii) generate sums of the weighted ordinates values, one sum per ordinate (e.g. a sum for red, a sum for green, . . . ), and (iv) normalize the sums to generate the corresponding pixel ordinate values. Filter process 360 is described in greater detail below (see description accompanying FIGS. 11, 12A, and 15).

In the embodiment just described, the filter kernel is a function of distance from the pixel center. However, in alternative embodiments, the filter kernel may be a more general function of X and Y displacements from the pixel center. Also, the support of the filter, i.e. the 2-D neighborhood over which the filter kernel takes non-zero values, may not be a circular disk. Any sample falling within the support of the filter kernel may affect the output pixel value being computed.

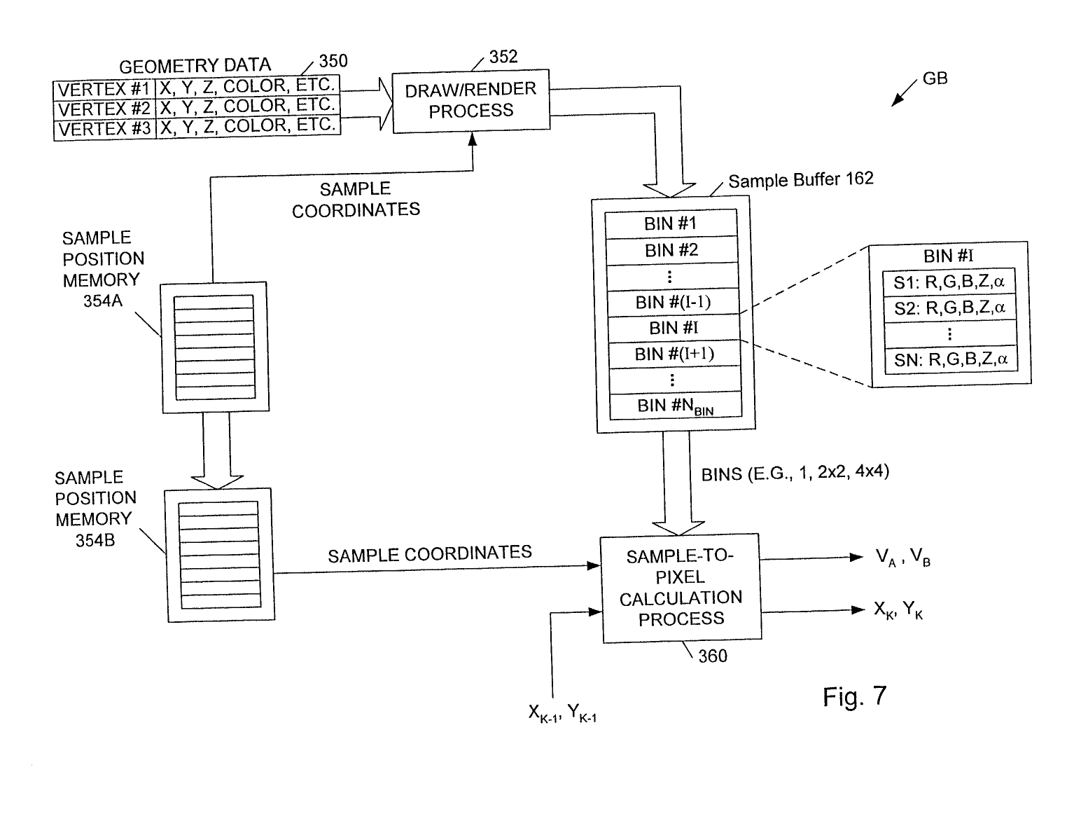

FIG. 7 illustrates an alternate embodiment of graphics board GB. In this embodiment, two or more sample position memories 354A and 354B are utilized. Sample position memories 354A-B may be used to implement double buffering of sample position data. If the sample positions remain the same from frame to frame, the sample positions may be single-buffered. However, if the sample positions vary from frame to frame, then graphics board GB may be advantageously configured to double-buffer the sample positions. The sample positions may be double-buffered on the rendering side (i.e., memory 354A may be double-buffered) and/or the filter side (i.e., memory 354B may be double-buffered). Other combinations are also possible. For example, memory 354A may be single-buffered, while memory 354B is doubled-buffered. This configuration may allow one side of memory 354B to be updated by sample position memory 354A while the other side of memory 354B is accessed by filter process 360. In this configuration, graphics board GB may change sample-positioning schemes on a per-frame basis by shifting the sample positions (or offsets) from memory 354A to double-buffered memory 354B as each frame is rendered. Thus, the sample positions which are stored in memory 354A and used by draw process 352 to render sample values may be copied to memory 354B for use by filter process 360. Once the sample position information has been copied to memory 354B, position memory 354A may then be loaded with new sample positions (or offsets) to be used for a second frame to be rendered. In this way the sample position information follows the sample values from the draw process 352 to the filter process 360.

Yet another alternative embodiment may store tags to offsets with the sample values in super-sampled sample buffer 162. These tags may be used to look-up the offset (i.e. perturbations) dX and dY associated with each particular sample.

FIGS. 8-10: Sample Positioning Schemes

FIG. 8 illustrates a number of different sample positioning schemes. In the regular positioning scheme 190, samples are positioned at fixed positions with respect to a regular grid which is superimposed on the 2-D viewport. For example, samples may be positioned at the center of the rectangles which are generated by the regular grid. More generally, any tiling of the 2-D viewport may generate a regular positioning scheme. For example, the 2-D viewport may be tiled with triangles, and thus, samples may be positioned at the centers (or vertices) of the triangular tiles. Hexagonal tilings, logarithmic tilings, and semi-regular tilings such as Penrose tilings are also contemplated.

In the perturbed regular positioning scheme 192, sample positions are defined in terms of perturbations from a set of fixed positions on a regular grid or tiling. In one embodiment, the samples may be displaced from their corresponding fixed grid positions by random x and y offsets, or by random angles (ranging from 0 to 360 degrees) and random radii (ranging from zero to a maximum radius). The offsets may be generated in a number of ways, e.g. by hardware based upon a small number of seeds, by reading a table of stored offsets, or by using a pseudo-random function. Once again, perturbed regular grid scheme 192 may be based on any type of regular grid or tiling. Samples generated by perturbation with respect to a grid or hexagonal tiling may be particularly desirable due to the geometric properties of these configurations.

Stochastic sample positioning scheme 194 represents a third potential type of scheme for positioning samples. Stochastic sample positioning involves randomly distributing the samples across the 2-D viewport. Random positioning of samples may be accomplished through a number of different methods, e.g., using a random number generator such as an internal clock to generate pseudo-random numbers. Random numbers or positions may also be pre-calculated and stored in memory.

Turning now to FIG. 9, details of one embodiment of perturbed regular positioning scheme 192 are shown. In this embodiment, samples are randomly offset from a regular square grid by x- and y-offsets. As the enlarged area shows, sample 198 has an x-offset 134 that specifies its horizontal displacement from its corresponding grid intersection point 196. Similarly, sample 198 also has a y-offset 136 that specifies its vertical displacement from grid intersection point 196. The random x-offset 134 and y-offset 136 may be limited to a particular range of values. For example, the x-offset may be limited to the range from zero to Xₘₐₓ, where Xₘₐₓ is the width of a grid rectangle. Similarly, the y-offset may be limited to the range from zero to Yₘₐₓ, where Yₘₐₓ is the height of a grid rectangle. The random offset may also be specified by an angle and radius with respect to the grid intersection point 196.

FIG. 10 illustrates details of another embodiment of the perturbed regular grid scheme 192. In this embodiment, the samples are grouped into rectangular bins 138A-D. In this embodiment, each bin comprises nine samples, i.e. has a bin capacity of nine. Different bin capacities may be used in other embodiments (e.g., bins storing four samples, 16 samples, etc.). Each sample's position may be determined by an x-offset and y-offset relative to the origin of the bin in which it resides. The origin of a bin may be chosen to be the lower-left corner of the bin (or any other convenient location within the bin). For example, the position of sample 198 is determined by summing x-offset 124 and y-offset 126 respectively to the x and y coordinates of the origin 132D of bin 138D. As previously noted, this may reduce the size of sample position memory 354 used in some embodiments.

FIG. 11—Computing Pixels from Samples

As discussed earlier, the 2-D viewport may be covered with an array of spatial bins. Each spatial bin may be populated with samples whose positions are determined by sample position memory 354. Each spatial bin corresponds to a memory bin in sample buffer 162. A memory bin stores the sample ordinate values (e.g. red, green, blue, Z, alpha, etc.) for the samples that reside in the corresponding spatial bin. Sample-to-pixel calculation units 170 (also referred to as convolve units 170) are configured to read memory bins from sample buffer 162 and to convert sample values contained within the memory bins into pixel values.

FIG. 11 illustrates one embodiment of a method for rapidly converting sample values stored in sample buffer 162 into pixel values. The spatial bins which cover the 2-D viewport may be organized into columns (e.g., Cols. 1-4). Each column comprises a two-dimensional subarray of spatial bins. The columns may be configured to horizontally overlap (e.g., by one or more spatial bins). Each of the sample-to-pixel calculation units 170-1 through 170-4 may be configured to access memory bins corresponding to one of the columns. For example, sample-to-pixel calculation unit 170-1 may be configured to access memory bins that correspond to the spatial bins of Column 1. The data pathways between sample buffer 162 and sample-to-pixel calculations unit 170 may be optimized to support this column-wise correspondence.

FIG. 11 shows four sample-to-pixel calculation units 170 for the sake of discussion. It is noted that graphics board GB may include any number of the sample-to-pixel calculation units 170.

The amount of the overlap between columns may depend upon the horizontal diameter of the filter support for the filter kernel being used. The example shown in FIG. 11 illustrates an overlap of two bins. Each square (such as square 188) represents a single bin comprising one or more samples. Advantageously, this configuration may allow sample-to-pixel calculation units 170 to work independently and in parallel, with each of the sample-to-pixel calculation units 170 receiving and convolving samples residing in the memory bins of the corresponding column. Overlapping the columns may prevent visual bands or other artifacts from appearing at the column boundaries for any operators larger than a pixel in extent.

Furthermore, the embodiment of FIG. 11 may include a plurality of bin caches 176 which couple to sample buffer 162. In addition, each of bin caches 176 couples to a corresponding one of sample-to-pixel calculation units 170. Bin cache 176-I (where I takes any value from one to four) stores a collection of memory bins from Column I, and serves as a cache for sample-to-pixel calculation unit 170-I. Bin cache 176-I may have an optimized coupling to sample buffer 162 which facilitates access to the memory bins for Column I. Since the convolution calculation for two adjacent convolution centers may involve many of the same memory bins, bin caches 176 may increase the overall access bandwidth to sample buffer 162.

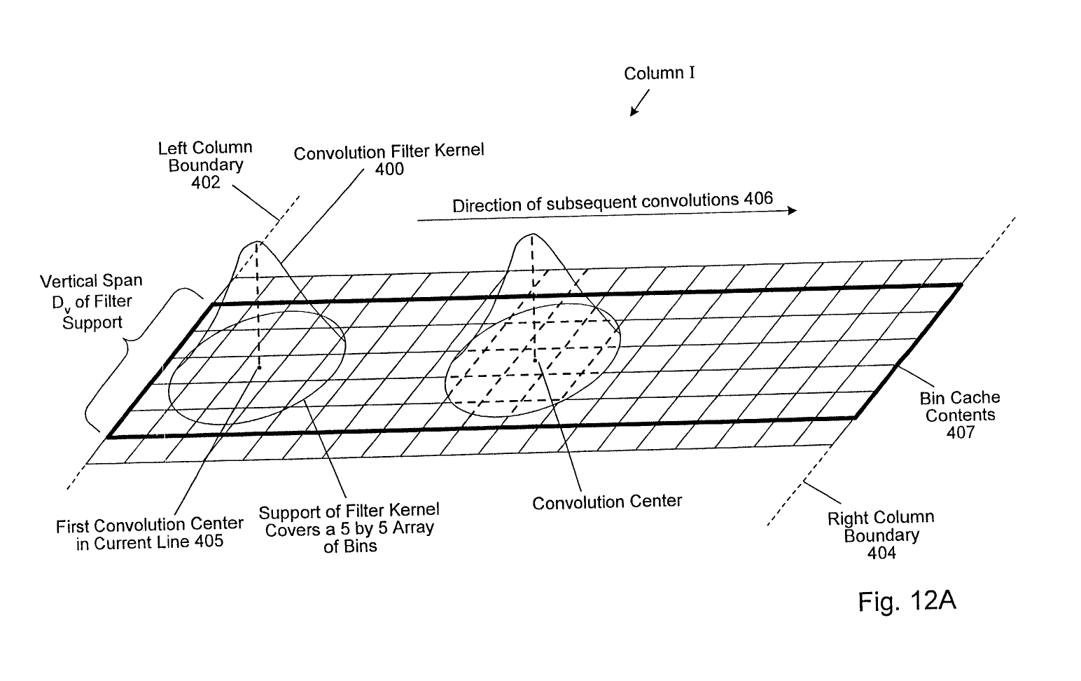

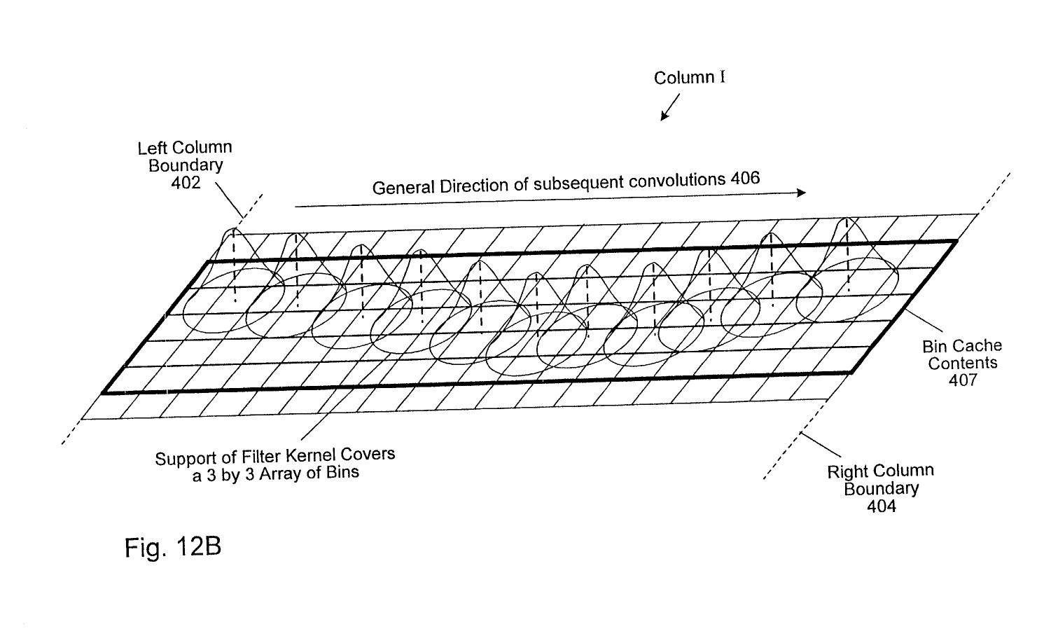

FIG. 12A illustrates more details of one embodiment of a method for reading sample values from super-sampled sample buffer 162. As the figure illustrates, the convolution filter kernel 400 travels across Column I (in the direction of arrow 406) to generate output pixel values, where index I takes any value in the range from one to four. Sample-to-pixel calculation unit 170-I may implement the convolution filter kernel 400. Bin cache 176-I may be used to provide fast access to the memory bins corresponding to Column I. Column I comprises a plurality of bin rows. Each bin row is a horizontal line of spatial bins which stretches from the left column boundary 402 to the right column boundary 404 and spans one bin vertically. In one embodiment, bin cache 176-I has sufficient capacity to store D_{L} bin rows of memory bins. The cache line-depth parameter D_{L} may be chosen to accommodate the support of filter kernel 400. If the support of filter kernel 400 is expected to span no more than Dᵥ bins vertically (i.e. in the Y direction), the cache line-depth parameter D_{L} may be set equal to Dᵥ or larger.

After completing convolution computations at a convolution center, convolution filter kernel 400 shifts to the next convolution center. Kernel 400 may be visualized as proceeding horizontally within Column I in the direction indicated by arrow 406. When kernel 400 reaches the right boundary 404 of Column I, it may shift down one or more bin rows, and then, proceed horizontally starting from the left column boundary 402. Thus the convolution operation proceeds in a scan line fashion, generating successive rows of output pixels for display.

In one embodiment, the cache line-depth parameter D_{L} is set equal to Dᵥ+1. In the example of FIG. 12A, the filter support covers Dᵥ=5 bins vertically. Thus, the cache line-depth parameter D_{L}=6=5+1. The additional bin row in bin cache 176-I allows the processing of memory bins (accessed from bin cache 176-I) to be more substantially out of synchronization with the loading of memory bins (into bin cache 176-I) than if the cache line-depth parameter D_{L} were set at the theoretical minimum value Dᵥ.

In one embodiment, sample buffer 162 and bin cache 176-I may be configured for row-oriented burst transfers. If a request for a memory bin misses in bin cache 176-I, the entire bin row containing the requested memory bin may be fetched from sample buffer 162 in a burst transfer. Thus, the first convolution of a scan line may fill the bin cache 176-I with all the memory bins necessary for all subsequent convolutions in the scan line. For example, in performing the first convolution in the current scan line at the first convolution center 405, sample-to-pixel calculation unit 170-I may assert a series of requests for memory bins, i.e. for the memory bins corresponding to those spatial bins (rendered in shade) which intersect the support of filter kernel 400. Because the filter support 400 intersects five bin rows, in a worst case scenario, five of these memory bin requests will miss bin cache 176-I and induce loading of all five bin rows from sample buffer 162. Thus, after the first convolution of the current scan line is complete, bin cache 176-I may contain the memory bins indicated by the heavily outlined rectangle 407. Memory bin requests asserted by all subsequent convolutions in the current scan line may hit in bin cache 176-I, and thus, may experience significantly decreased bin access time.

In general, the first convolution in a given scan line may experience fewer than the worst case number of misses to bin cache 176-I because bin cache 176-I may already contain some or all of the bin rows necessary for the current scan line. For example, if convolution centers are located at the center of each spatial bin, the vertical distance between successive scan lines (of convolution centers) corresponds to the distance between successive bin rows, and thus, the first convolution of a scan line may induce loading of a single bin row, the remaining four bin rows having already been loaded in bin cache 176-I in response to convolutions in previous scan lines.

If the successive convolution centers in a scan line are expected to depart from a purely horizontal trajectory across Column I, the cache line-depth parameter D_{L} may be set to accommodate the maximum expected vertical deviation of the convolution centers. For example, in FIG. 12B, the convolution centers follow a curved path across Column I. The curved path deviates from a horizontal path by approximately two bins vertically. Since the support of the filter kernel covers a 3 by 3 array of spatial bins, bin cache 176-I may advantageously have a cache line-depth D_{L} of at least five (i.e. two plus three).

As mentioned above, Columns 1 through 4 of the 2-D viewport may be configured to overlap horizontally. The size of the overlap between adjacent Columns may be configured to accommodate the maximum expected horizontal deviation of convolution centers from nominal convolution centers on a rectangular grid.

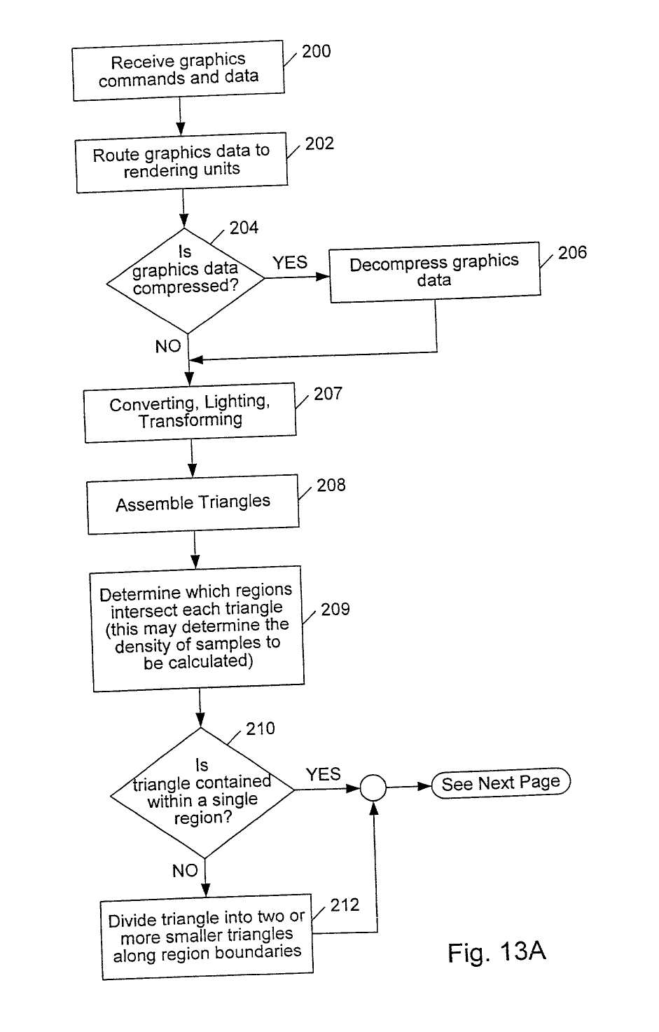

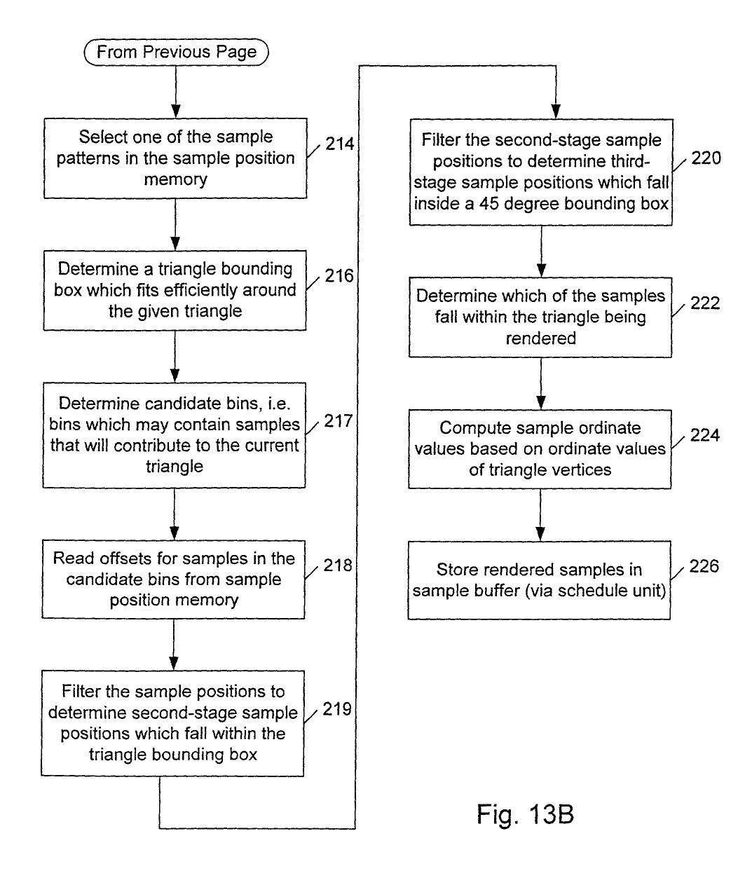

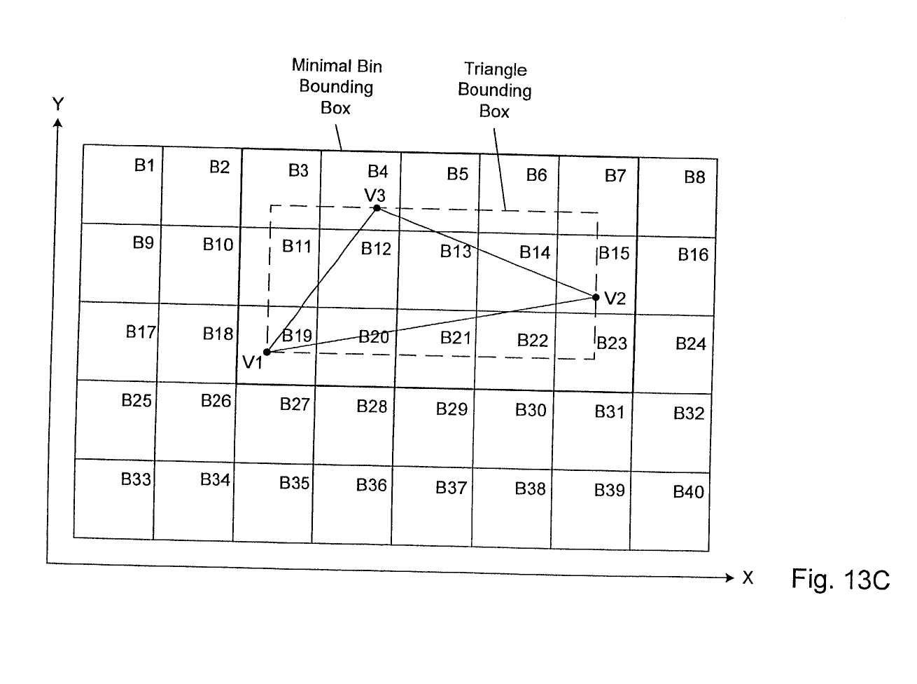

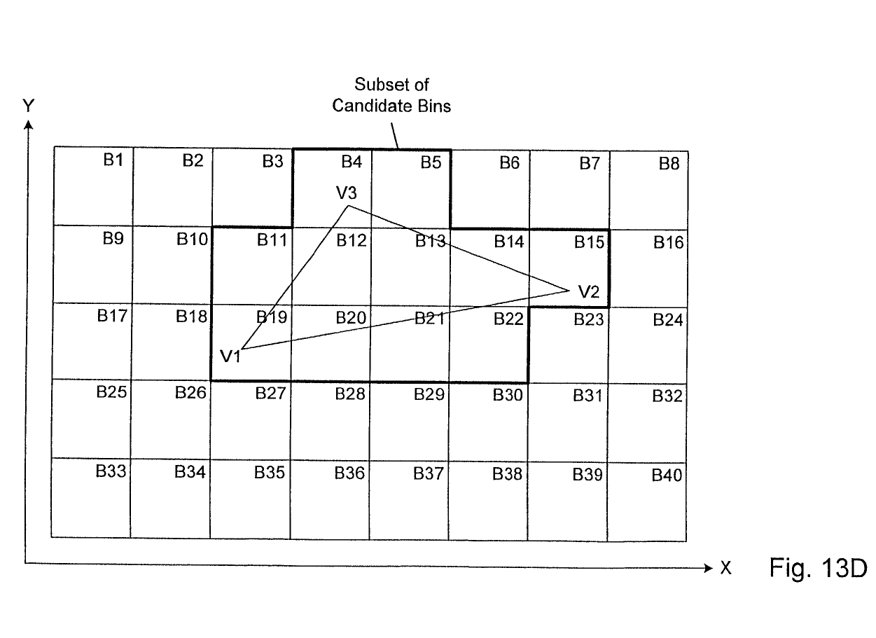

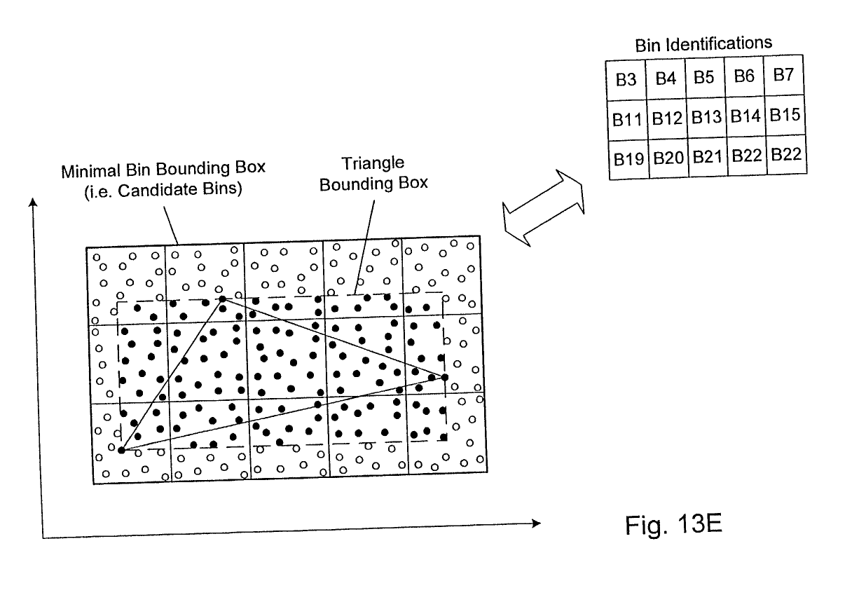

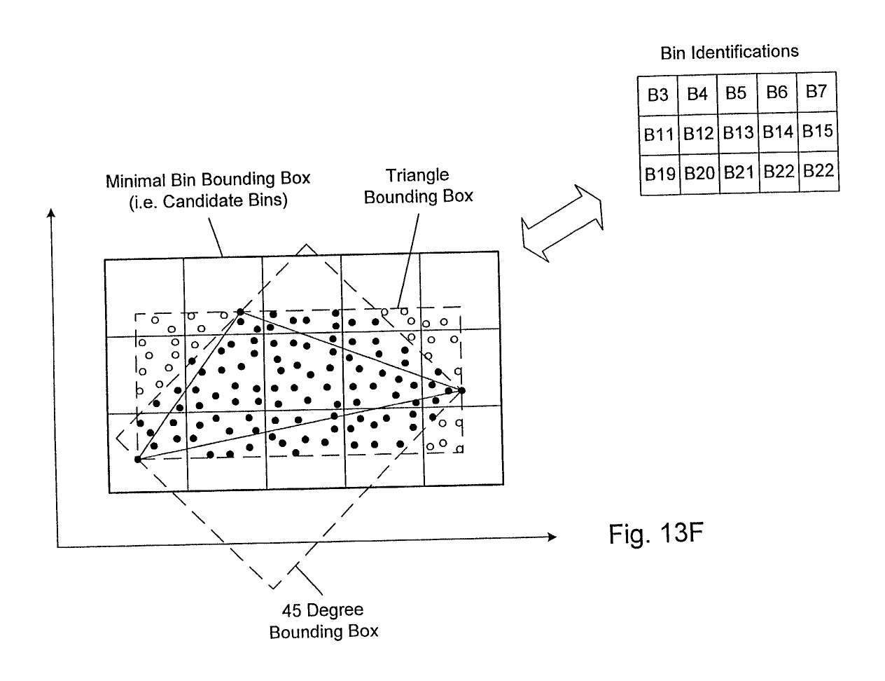

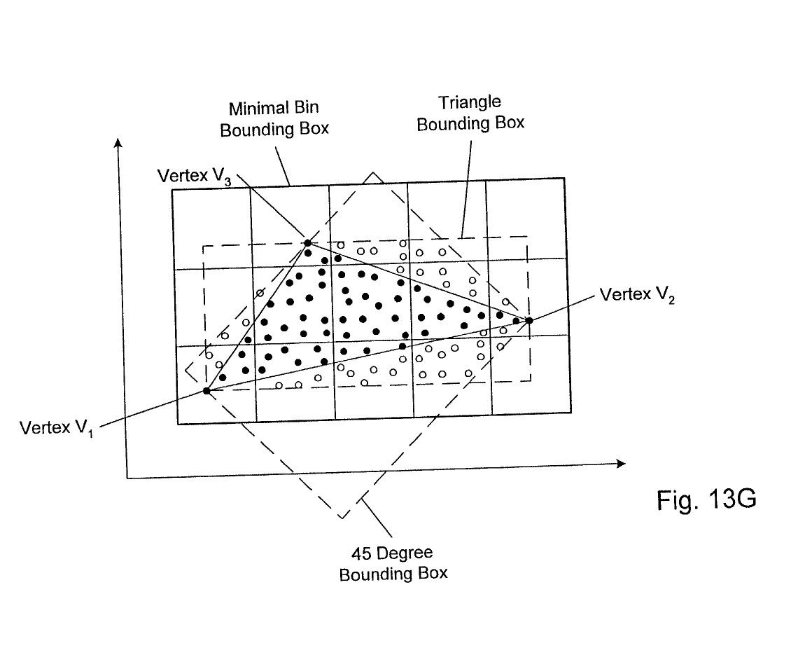

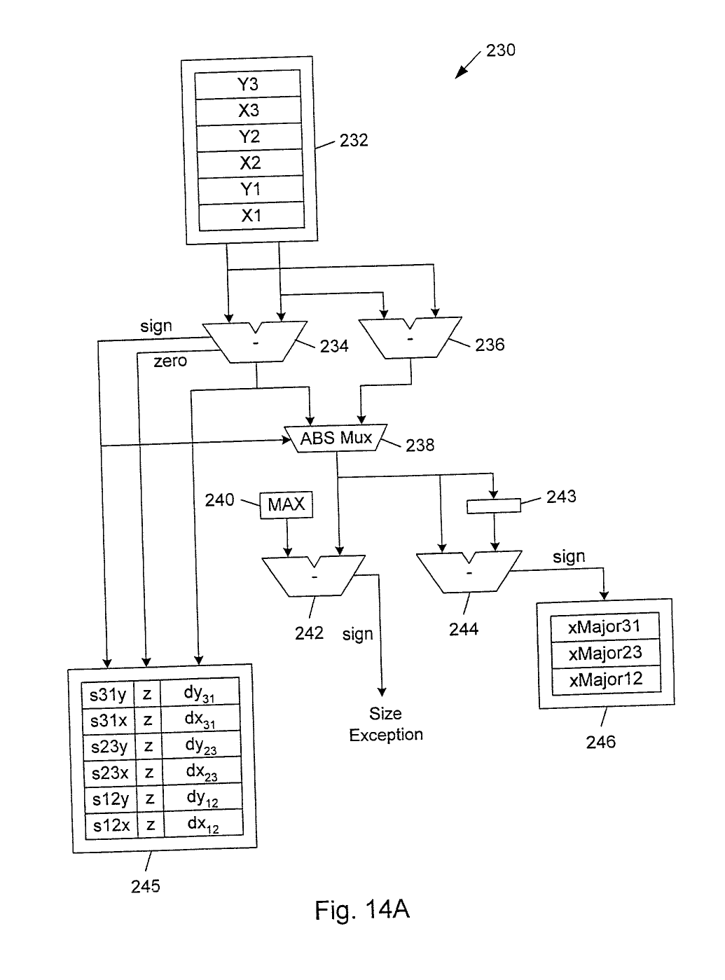

FIGS. 13A&B—Rendering Samples into a Super-sampled Sample Buffer

FIGS. 13A&B illustrate one embodiment of a method for drawing or rendering samples into a super-sampled sample buffer. Certain of the steps of FIGS. 13A&B may occur concurrently or in different orders. In step 200, control unit 140 may receive graphics commands and graphics data from the host CPU 102 and/or directly from system memory 106. In step 202, control unit 140 may route the instructions and data to one or more of rendering units 150A-D. In step 204, a rendering unit, say rendering unit 150A for the sake of discussion, may determine if the graphics data is compressed. If the graphics data is compressed, rendering unit 150A may decompress the graphics data into a useable format, e.g., into a stream of vertex data structures, as indicated in step 206. Each vertex data structure may include x, y, and z coordinate values defining a point in a three dimensional space, and color values. A vertex data structure may also include an alpha value, normal vector coordinates Nₓ, N_{y} and N_{z}, texture map values, etc.

In step 207, rendering unit 150A may process the vertices and convert the vertices into an appropriate space for lighting and clipping prior to the perspective divide and transform to virtual screen space. In step 208, rendering unit 150A may assemble the stream of vertex data structures into triangles.

If the graphics board GB implements variable resolution super-sampling, rendering unit 150A may compare the triangles with a set of sample-density region boundaries (as indicated in step 209). In variable-resolution super-sampling, different regions of the 2-D viewport may be allocated different sample densities based upon a number of factors (e.g., the center of the attention of an observer on projection screen SCR as determined by eye or head tracking). If the triangle crosses a sample-density region boundary (step 210), then the triangle may be divided into two smaller polygons (e.g. triangles) along the region boundary (step 212). The polygons may be further subdivided into triangles if necessary (since the generic slicing of a triangle gives a triangle and a quadrilateral). Thus, each newly formed triangle may be assigned a single sample density. In one embodiment, rendering unit 150A may be configured to render the original triangle twice, i.e. once with each sample density, and then, to clip the two versions to fit into the two respective sample density regions.

In step 214, rendering unit 150A selects one of the sample positioning schemes (e.g., regular, perturbed regular, stochastic, etc.) from sample position memory 354. In one embodiment, the sample positioning scheme may be pre-programmed into the sample position memory 354. In another embodiment, the sample-positioning scheme may be selected “on the fly”.

In step 216, rendering unit 150A may operate on the vertices of a given triangle to determine a triangle bounding box which forms a tight bound around the given triangle as shown in FIG. 13C. For example, rendering unit 150A may determine the edges of the triangle bounding box by computing the minimum and maximum of the x and y coordinates of the triangle vertices.

In step 217, rendering unit 150A may determine a subset of spatial bins which, based on their positional relation to the given triangle, may contribute samples that fall within the given triangle. The bins in this subset are referred to herein as candidate bins. In one embodiment, rendering unit 150A may determine the candidate bins by computing a minimal bin bounding box, i.e. a minimal rectangle of bins which efficiently contains the triangle bounding box, as suggested in FIG. 13C. The edge coordinates of the minimal bin bounding box may be computed by:

(a) rounding down each of the lower and left edge coordinates of the triangle bounding box to the nearest bin edge coordinate; and

(b) rounding up each of the upper and right edge coordinates of the triangle bounding box to the nearest bin edge coordinate.

Thus, the minimal bin bounding box may comprise a subset of all possible candidate bins. In another embodiment, rendering unit 150A may use triangle vertex data to determine a more efficient (i.e. smaller) subset of candidate bins as shown in FIG. 13D. Rendering unit 150A may eliminate bins in the minimal bin bounding box which have no intersection with the triangle.

In step 218, rendering unit 150A may compute a set of sample positions for each of the candidate bins by reading positional offsets dX and dY from sample position memory 354 and adding the positional offsets to the coordinates of the corresponding bin origin.

In step 219, rendering unit 150A may filter the sample positions in the candidate bins with respect to the triangle bounding box as shown in FIG. 13E. For example, rendering unit 150A may compare the x coordinate x_{S} of each sample position to the x coordinates x_{left} and x_{right} of the left and right edges of the triangle bounding box, and the y coordinate y_{S} of each sample position to the y coordinates y_{lower} and yᵤₚₚₑᵣ of the lower and upper edges of the triangle bounding box. A sample position may be designated as inside the triangle bounding box if x_{left}≦x_{S}≦x_{right} and y_{lower}≦y_{S}≦yᵤₚₚₑᵣ. The sample positions which are determined to be inside the triangle bounding box are referred to herein as second-stage sample positions. In one embodiment, rendering unit 150A may comprise dedicated circuitry to perform the edge coordinate comparisons.

In step 220, the rendering unit 150A may filter the second-stage sample positions with respect to a 45 degree bounding box as shown in FIG. 13F. The 45 degree bounding box may be a rectangle with sides of slope one and minus one with the respect to the virtual screen space coordinates x and y. The 45 degree bounding box preferably fits tightly around the given triangle. Thus, the sides of the 45 degree bounding box obey the equations:

y=x+b₁

y=x+b₂

y=−x+b₃

y=−x+b₄

where the coefficients bᵢ are y-intercepts, b₁ for the upper-left edge, b₂ for the lower-right edge, b₃ for the upper-right edge, and b₄ for the lower-left edge. The rendering unit 150A may determine:

b₁ by computing the maximum of the quantity (y−x) evaluated at the vertices of the given triangle;

b₂ by computing the minimum of the quantity (y−x) evaluated at the vertices of the given triangle;

b₃ by computing the maximum of the quantity (y+x) evaluated at the vertices of the given triangle; and

b₄ by computing the minimum of the quantity (y+x) evaluated at the vertices of the given triangle.

Rendering unit 150A filters each second-stage sample position (x_{S}, y_{S}) by computing the quantities

Q₁=x_{S}−y_{S}+b₁

Q₂=x_{S}−y_{S}+b₂

Q₃=x_{S}+y_{S}−b₃

Q₄=x_{S}+y_{S}−b_{4,}

and examining the signs of these quantities. The second-stage sample position (x_{S}, y_{S}) is inside the 45 degree bounding box if Q₁ is positive, and Q₂ is negative, and Q₃ is negative, and Q₄ is positive.

Because the sides of the 45 degree bounding box have slopes of one or minus one, the computation of the edge test values Q₁, Q₂, Q₃ and Q₄ may be performed with four additions and four subtractions per sample position. In particular, observe that multiplications are not required as would be the case to test against a more general edge slope. Thus, the edge test values may be determined rapidly. The second-stage sample positions which are inside the 45 degree bounding box will be referred to herein as third-stage sample positions.

In one embodiment, rendering unit 150A may comprise dedicated circuitry to perform the computation of edge test values Q₁, Q₂, Q₃ and Q₄, and to examine the signs of the edge test values.

In step 222, rendering unit 150A may filter the third-stage sample-positions with respect to the given triangle as suggested in FIG. 13G. In other words, rendering unit 150A may operate on the third-stage sample positions to determine those that reside inside the triangle. In one embodiment, rendering unit 150A may use the triangle vertices to compute parameters for linear edge equations corresponding to the three edges of the triangle. For each of the third-stage sample positions, rendering unit 150A may compute a vertical or horizontal displacement of the sample with respect to each of the three edges of the triangle. Rendering unit 150A may examine the signs of the three edge-relative displacements to determine whether the sample position is inside or outside the triangle. Step 222 is discussed in greater detail below.

For each sample position that is determined to be within the triangle, rendering unit 150A may interpolate sample ordinate values (e.g. color values, alpha, Z, texture values, etc.) based on the known ordinate values of the vertices of the triangle as indicated in step 224. In step 226, render unit 150A may forward the rendered sample ordinate values to schedule unit 154, which then stores the samples in sample buffer 162.

The embodiment of the rendering method described above is not meant to be limiting. For example, in some embodiments, two or more of the steps shown in FIGS. 13A-B as occurring serially may be implemented in parallel. Furthermore, some steps may be reduced or eliminated in certain embodiments of the graphics system (e.g., steps 204-206 in embodiments that do not implement geometry compression, or steps 210-212 in embodiments that do not implement a variable resolution super-sampled sample buffer). In one alternative embodiment, the 45 degree box filtration of step 220 precedes the triangle bounding box filtration of step 219.

Determination of Samples Residing within the Triangle being Rendered

As described above, in step 222 rendering unit 150A may determine which of the third-stage sample positions reside within the triangle being rendered. The following is a more elaborate description of one embodiment of step 222.

Let V₁, V₂ and V₃ denote the vertices of the triangle to be rendered. Each vertex comprises x and y coordinates: V₁=(x₁, y₁), V₂=(x₂,y₂), V₃=(x₃, y₃). Rendering unit 150A may compute x and y displacements between pairs of vertices:

dx₁₂=x₂−x₁,

dy₁₂=y₂−y₁,

dx₂₃=x₃−x₂,

dy₂₃=y₃−y₂,

dx₃₁=x₁−x₃,

dy₃₁=y₁−y₃,

These x and y displacements represent the x and y components of vector displacements

d₁₂=V₂−V₁,

d₂₃=V₃−V₂,

d₃₁=V₁−V₃,

one vector displacement for each edge of the triangle. Observe that the sign bit of x displacement dxᵢₖ determines whether vector displacement dᵢₖ lies in the right or left half planes of the coordinate plane, and the sign bit of y displacement dyᵢₖ determines whether the vector displacement dᵢₖ lies in the upper or lower half planes.

Rendering unit 150A may further determine whether each edge is X major or Y major. An edge is said to be X major if the absolute value of its x displacement is larger than the absolute value of its y displacement. Conversely, an edge is said to be Y major if the absolute value of its x displacement is less than the absolute value of its y displacement. Thus, for each vector displacement dᵢₖ of the given triangle, rendering unit 150A may compute the absolute value of x displacement dxᵢₖ and y displacement dyᵢₖ, compare the two absolute values, and set an xMajor flag associated with edge Eik in response to the result of the comparison. The larger displacement is referred to as the major axis delta for the edge, and the smaller displacement is referred to as the minor axis delta for the edge.

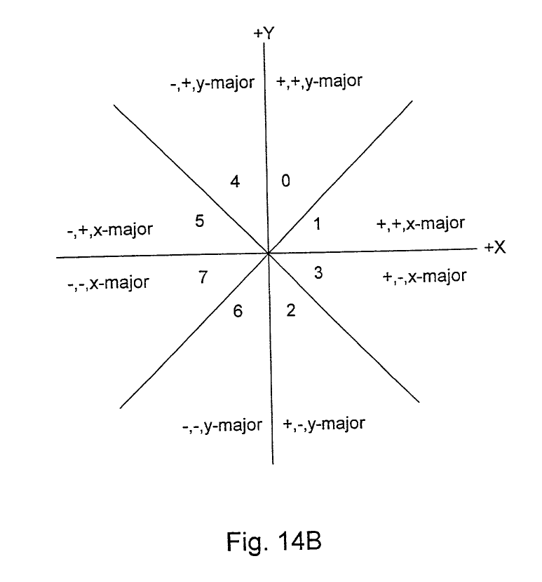

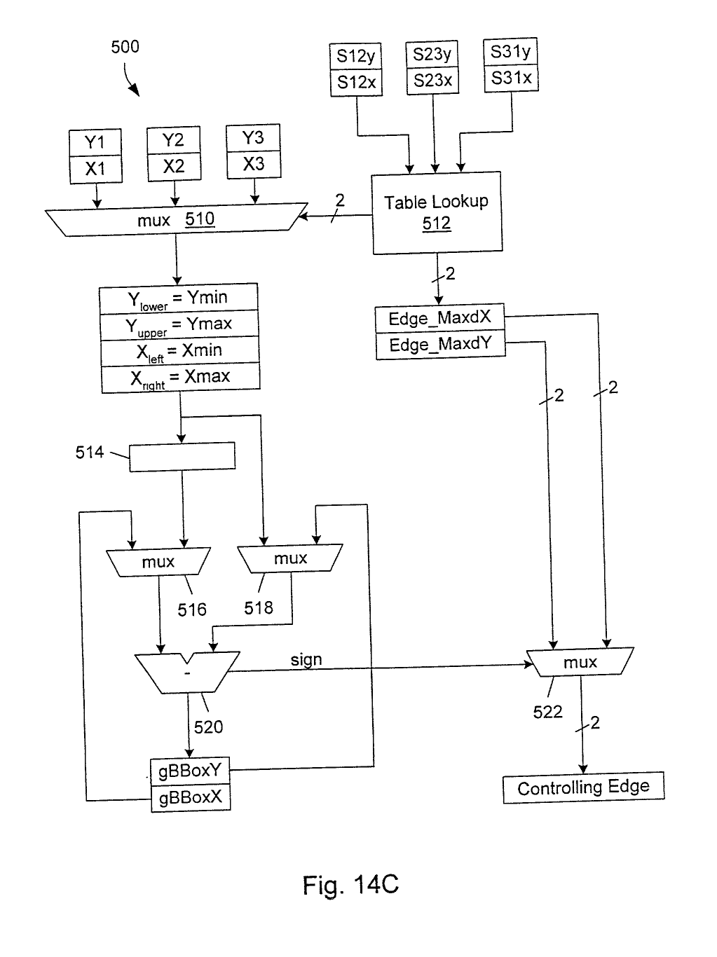

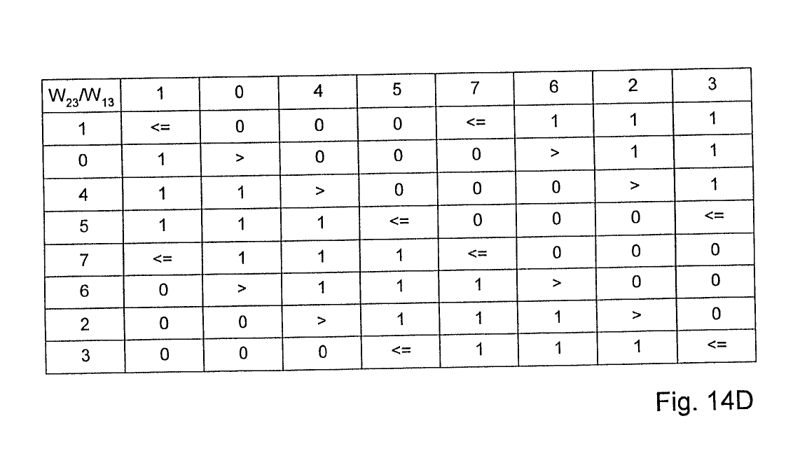

Rendering unit 150A may include an edge delta unit 230 for computing the x and y edge displacements and determining the xMajor flag for each edge Eik as shown in FIG. 14A. Edge delta unit 230 may comprise an input buffer 232, subtractors 234, 236, 242 and 244, a multiplexor 238, a maximum size register 240, a delay unit 243 an output buffer 245 and a flag buffer 246. Input buffer 232 may store the coordinates xₖ and yₖ of the triangle vertices. Subtractor 234 may compute one of the x and y displacements dx₁₂, dy₁₂, dx₂₃, dy₂₃, dx₃₁ and dy₃₁ in each clock cycle, and stores these displacements in output buffer 245. Subtractor 236 may compute B-A for each difference A-B computed by subtractor 234. Thus, subtractors 234 and 236 generate an x displacement dxᵢₖ and its negative respectively in one clock cycle, and a y displacement dyᵢₖ and its negative in the next clock cycle. Multiplexor 238 may select the positive of the two opposite signed inputs. Thus, the output of the multiplexor is the absolute value of the x displacement dxᵢₖ or y displacement dyᵢₖ. The multiplexor 238 may be controlled by the sign bit output of subtractor 234. The output of multiplexor 238 may feed an input of subtractor 244 and delay unit 243. Subtractor 244 may compare the absolute value of dxᵢₖ to the absolute value dyᵢₖ. The sign bit output of subtractor 244 may determine the xMajor bit for each edge Eik. The output of multiplexor 238 may also be supplied to subtractor 242. Subtractor 242 may compare the absolute value of x displacement dxᵢₖ to a maximum triangle size in a first clock cycle, and compare the absolute value of y displacement dyᵢₖ to the maximum triangle size in a second clock cycle. If any of the x or y displacements exceeds the maximum triangle size, the triangle may be sent back to an earlier rendering stage for fragmenting into smaller pieces.

In an alternative embodiment, three edge delta units, one for each edge of the triangle, may operate in parallel, and thus, may generate x and y displacements for the three triangle edges more quickly than edge delta unit 230.

The coordinate plane may be divided into eight regions (referred to herein as octants) by the coordinate axes and the lines y=x and y=−x as shown in FIG. 14B. The octant in which an edge displacement vector dᵢₖ=(dxᵢₖ, dyᵢₖ) belongs may be determined by the sign bit of dxᵢₖ, the sign bit of dyᵢₖ and the xMajor bit for the displacement dᵢₖ. A three-bit word A₂A₁A₀ may be composed by setting bit A₂ equal to the sign bit of dxᵢₖ, setting bit A₁ equal to the sign bit of dyᵢₖ, and setting bit A₀ equal to the xMajor bit. Hereafter, the three-bit word A₂A₁A₀ is referred to as the octant identifier word. FIG. 14B shows each octant labeled with its corresponding octant identifier word expressed in decimal. It is noted that the assignment of the dx and dy sign bits and the xMajor bit to the bit positions of the octant identifier word is arbitrary. Other assignments are contemplated.

In one embodiment, rendering unit 150A may examine the sign bits of the x displacements dx₁₂, dx₂₃ and dx₃₁ to determine how the vertex coordinates x₁, x₂ and x₃ are ordered along the x axis, and examine the sign bits of y displacements dy₁₂, dy₂₃ and dy₃₁ to determine how the vertex coordinates y₁, y₂ and y₃ are ordered along the y axis. Thus, as described above, rendering unit 150A may determine edge coordinates for the triangle bounding box as follows:

gBBoxUx=xₘₐₓ,

gBBoxLx=xₘᵢₙ,

gBBoxUy=yₘₐₓ,

gBBoxLy=yₘᵢₙ,

where xₘₐₓ is a maximum of the values x₁, x₂ and x₃, xₘᵢₙ is a minimum of the values x₁, x₂ and x₃, yₘₐₓ is a maximum of the values y₁, y₂ and y₃, and yₘᵢₙ is a minimum of the values y₁, y₂ and y₃. Rendering unit 150A may compute the width gBBoxX and height gBBoxY of the triangle bounding box according to the relations

gBBoxX=gBBoxUx−gBBoxLx,

gBBoxY=gBBoxUy−gBBoxLy.

Rendering unit 150A may compare values gBBoxX and gBBoxY to determine the triangle's controlling edge. The controlling edge is the edge that has the largest major axis delta.

In one embodiment, rendering unit 150A may comprise a feedback network 500 for determining the width and height of the triangle bounding box, and the controlling edge. One embodiment of feedback network 500 is shown in FIG. 14C. Feedback network may include a multiplexor 510, table lookup unit 512, delay unit 514, multiplexors 516 and 518, subtract unit 520, and multiplexor 522.

In a first clock cycle, table lookup unit 512 uses the sign bits of the x displacements dx₁₂, dx₂₃ and dx₃₁ to lookup a two-bit code defining the edge having the largest x displacement, and a two-bit code for the vertex having the maximum x coordinate among the three vertices of the triangle. Multiplexor 510 receives the x coordinates x₁, x₂ and x₃ as input, and outputs the value xₘₐₓ in response to the selection indicated by table lookup unit 512. The value xₘₐₓ is assigned to the value gBBoxUx.

In a second clock cycle, table lookup unit 512 uses the sign bits of the x displacements dx₁₂, dx₂₃ and dx₃₁ to lookup a two-bit code for the vertex having the minimum x coordinate among the three vertices of the triangle. Multiplexor 510 receives the x coordinates x₁, x₂ and x₃ as input, and outputs the value xₘᵢₙ in response to the selection indicated by table lookup unit 512. The value xₘᵢₙ is assigned to the value gBBoxLx.

In a third clock cycle, table lookup unit 512 uses the sign bits of the y displacements dy₁₂, dy₂₃ and dy₃₁ to lookup a two-bit code defining the edge having the largest y displacement, and a two-bit code for the vertex having the maximum y coordinate among the three vertices of the triangle. Multiplexor 510 receives the y coordinates y₁, y₂ and y₃ as input, and outputs the value ymax in response to the selection indicated by table lookup unit 512. The value yₘₐₓ is assigned to the value gBBoxUy. Multiplexors 516 and 518 feed subtraction unit 520 with the values gBBoxUx and gBBoxLx respectively, and subtraction unit 520 computes the bounding box width gBBoxX=gBBoxUx−gBBoxLx. Delay unit 514 operates to delay the value gBBoxUx until value gBBoxLx is available.

In a fourth clock cycle, table lookup unit 512 uses the sign bits of the y displacements dy₁₂, dy₂₃ and dy₃₁ to lookup a two-bit code for the vertex having the minimum y coordinate among the three vertices of the triangle. Multiplexor 510 receives the y coordinates y₁, y₂ and y₃ as input, and outputs the value yₘᵢₙ in response to the selection indicated by table lookup unit 512. The value yₘᵢₙ is assigned to the value gBBoxLy.

In a fifth clock cycle, multiplexors 516 and 518 feed the values gBBoxUy and gBBoxLy respectively to subtraction unit 520. Subtraction unit 520 computes the difference gBBoxY=gBBoxUy−gBBoxLy. In a sixth clock cycle, multiplexors 516 and 518 feed the values gBBoxX and gBBoxY respectively to subtraction unit 520. Subtraction unit 520 computes the difference gBBoxX−gBBoxY. Multiplexor 522 receives the two bit code for the edge Edge_MaxdX with maximum x displacement, and the two bit code for the edge Edge_MaxdY with maximum y displacement. Multiplexor 522 outputs the value Edge_MaxdX if the subtraction unit 520 indicates that the difference gBBoxX−gBBoxY is non-negative, and the value Edge_MaxdY otherwise. The output of multiplexor 522 determines the controlling edge, i.e. the edge having the largest major axis delta (i.e. displacement).

Rendering unit 150A may use the triangle bounding box coordinates gBBoxUx, gBBoxLx, gBBoxUy and gBBoxLy to generate coordinates for the bin bounding box. See FIG. 13C. In one embodiment, bin boundaries occur on vertical lines given by x equal to any integer and on the horizontal lines given by y equal to any integer. In this case, rendering unit 150A may compute bin bounding box values according to the relations

bBBMaxX=ceil(gBBoxUx),

bBBMinX=floor(gBBoxLx),

bBBMaxY=ceil(gBBoxUy),

bBBMinY=floor(gBBoxLy),

where ceil(*) denotes the ceiling (or rounding up) function, and floor(*) denotes the floor (or rounding down) function.

Rendering unit 150A may compute new coordinates for the vertices and the triangle bounding box relative to a corner of the bin bounding box according to the relations

relXₖ=Xₖ−bBBMinX,

relYₖ=yₖ−bBBMinY,

relMaxX=gBBoxUx−bBBoxMinX,

relMinX=gBBoxLx−bBBoxMinX,

relMaxY=gBBoxUy−bBBoxMinY,

relMinY=gBBoxLx−bBBoxMinY.

By computing relative coordinates, rendering unit 150A may use smaller adders and multipliers in succeeding computational stages.

Rendering unit 150A may compute parameters m and b for a line equation y=mx+b or x=my+b for each edge of the triangle depending on whether the edge is X major or Y major, i.e. depending on the value of the xMajor flag for the edge. If an edge Eᵢₖ is X major, rendering unit 150A may compute parameters mᵢₖ and bᵢₖ for the line equation in the form y=mᵢₖx+bᵢₖ, i.e. mᵢₖ=dyᵢₖ*(1/dxᵢₖ) and bᵢₖ=yₖ−m*xₖ. If the edge Eik is Y major, rendering unit 150A may compute parameters mᵢₖ and bᵢₖ for the line equation in the form x=mᵢₖy+bᵢₖ, i.e. mᵢₖ=dxᵢₖ*(1/dyᵢₖ) and bᵢₖ=xₖ−m*yₖ. By computing the slope and intercept for each edge in this major-sensitive fashion, slopes are guaranteed to be between negative one and one. It is noted that the reciprocal values (1/dxᵢₖ) and (1/dyᵢₖ) may be computed by lookup in a ROM table. Also, the intercept values bᵢₖ may be computed in terms of relative x and y coordinates, i.e. bᵢₖ=relYₖ−m*relXₖ or bᵢₖ=relXₖ−m*relYₖ. In this fashion, smaller adders and multipliers may be used to compute the intercepts. Henceforth, wherever rendering computations involving x and y vertex coordinate values are presented, it is to be understood that the corresponding relative x and y vertex coordinate values may be used instead in some embodiments.

Given an X-major edge Eik with edge equation y=mx+b, the inequality

y−mx−b<0 (1)

is true if and only if the point (x,y) resides below the line given by y=mx+b. Conversely, the inequality

y−mx−b>0 (2)

is true if and only if the point (x,y) resides above the line given by y=mx+b. The interior of the triangle lies either above or below the line y=mx+b. The side (i.e. half plane) which contains the triangle interior is referred to herein as the interior side or the “accept” side. The accept side may be represented by an ACCEPT flag. The ACCEPT flag is set to zero if the interior side is below the line y=mx+b, and is set to one if the interior side is above the line. A given sample S with coordinates (x_{S}, y_{S}) is on the accept side of the edge Eik if the expression

(y_{S}−-m*x_{S}−b<0) XOR ACCEPT

is true.

Given a Y-major edge Eik with edge equation x=my+b, the inequality

x−my−b<0 (3)

is true if and only if the point (x,y) resides to the left of the line given by x=my+b. Conversely, the inequality

x−my−b>0 (4)

is true if and only if the point (x,y) resides to the right of the line given by x=my+b. Again, the accept side (i.e. interior side) of the line may be represented by an ACCEPT flag. A sample S with coordinates (x_{S}, y_{S}) is on the accept side of the edge Eik if the expression

(x_{S}−m*y_{S}−b<0) XOR ACCEPT

is true.

Rendering unit 150A may perform inequality testing on the third-stage sample positions as described above for all three edges of the given triangle. If a sample position lies on the accept side (i.e. the interior side) of all three edges, it is in the interior of the triangle, and rendering unit 150A may set a VALID bit for the sample position. If the sample position lies outside the triangle, the sample position lies on the exterior side of one or more edges.

Rendering unit 150A may implement these sample-testing computations in hardware (e.g. in an ASIC chip). In one embodiment, rendering unit 150A may include one or more sample test circuits. A sample test circuit may comprise a multiplier, two subtraction units, an XOR gate and two multiplexors. The sample test circuit may receive as input the x and y coordinates of a sample, the m and b parameters for a given edge, the ACCEPT bit and the xMajor bit for the edge. The multiplexors may receive the x and y coordinates as inputs, and provide output values j and n. The multiplexors may pass the inputs to the outputs with exchange (j=y and n=x) or without exchange (j=x and n=y) depending on the state of the xMajor bit. The multiplier may compute the product m*j, and the first subtraction unit may compute the difference n−b. The second subtraction unit may compute the expression EXP=(n−b)−(m*j). The expression EXP may be stored in memory for use in a later rendering stage. The XOR gate may receive the sign bit from the second subtraction unit and the ACCEPT flag, and may generate an EDGE_VALID bit.

In one embodiment, rendering unit 150A may comprise three sample test circuits, one for each edge, operating in parallel on the stream of third-stage sample positions. The sample test circuit which operates on edge Eik receives the corresponding ACCEPT flag and the corresponding xMajor flag. A three-input AND circuit may compute the logical AND of the three EDGE_VALID bits, one for each edge. The output of the three-input AND circuit may determine a VALID bit for the input sample. The VALID bit specifies whether or not the sample is inside or outside the triangle.

In one embodiment, the accept side (i.e. the interior side) for each edge may be determined from the orientation flag CW for the triangle and the octant identifier word for the displacement vector corresponding to the edge. A triangle is said to have clockwise orientation if a path traversing the edges in the order V3, V2, V1 moves in the clockwise direction. Conversely, a triangle is said to have counter-clockwise orientation if a path traversing the edges in the order V3, V2, V1 moves in the counter-clockwise direction. It is noted the choice of vertex order for the orientation definition is arbitrary, and other choices are contemplated.

The ACCEPT bit for an edge Eik may be determined by the following table based on (a) the octant identifier word A₂A₁A₀ of the displacement vector dik corresponding to the edge Eik, and (b) orientation flag CW for the triangle, where clockwise traversal is indicated by CW=1 and counter-clockwise traversal is indicated by CW=0. The notation “!” denotes the logical complement. The octant identifier words are given as decimal values zero through seven.

TABLE
Interior Side Resolution Table

1: ACCEPT = !CW
0: ACCEPT = CW
4: ACCEPT = CW
5: ACCEPT = CW
7: ACCEPT = CW
6: ACCEPT = !CW
2: ACCEPT = !CW
3: ACCEPT = !CW

Tie breaking rules for this representation may also be implemented. For example, an edge displacement vector dᵢₖ which lies on one of the coordinate axes may be defined as belonging to the adjacent octant with positive sign along the complementary coordinate. Thus, a displacement vector dik on the negative y-axis would belong to octant 2 because octant 2 is associated with positive x coordinate. An edge displacement vector dᵢₖ which resides on a line of slope m=1 or −1 may be defined as belonging to the adjacent X major octant.

Rendering unit 150A may determine the orientation flag CW of a triangle by table-lookup in an orientation table which is addressed by the octant identifier words for vector displacements d₁₃ and d₂₃. An illustration of the orientation table is provided in FIG. 14D. W₁₃ denotes the octant identifier word for displacement d₁₃, and W₂₃ denotes the octant identifier word for displacement d₂₃. The octant identifier word W₂₃ addresses the rows of the orientation table, and octant identifier word W₁₃ addresses the columns of the orientation table. The octant identifier words are given as decimal values. The entries in the orientation table are values for the orientation flag. It is noted that the orientation flag CW may be tabulated with respect to any two of the vector edge displacements d₁₂, d₂₃ and d₃₁.

As an example of the orientation table lookup, suppose that vector displacement d₁₃ resides in octant 1 (i.e. W₁₃=1) and vector displacement d₂₃ resides in octants 0, 4 or 5 (i.e. W₂₃=0, 4 or 5). In these cases, the given triangle has clockwise orientation (i.e. CW=1). If, however, vector displacement d₂₃ reside in octants 6, 2, or 3 (i.e. W₂₃=6, 2, or 3), the triangle has counter-clockwise orientation (i.e. CW=0).

It is noted that certain entries in the table denoted with the symbol “>” or “<=”. These special entries occur where vector displacements d₁₃ and d₂₃ occupy either the same octant (i.e. W₁₃=W₂₃) or opposite octants. In these special cases, it is necessary to examine the slopes m₁₂ and m₂₃ of the vector displacements d₁₃ and d₂₃ respectively. As described above, rendering unit 150A may compute each slope by dividing the change in minor axis coordinate by the change in major axis coordinate along the corresponding vector displacement. The minor axis of a vector displacement [edge] is the axis complementary to the major axis of the vector displacement [edge].

In the special cases, rendering unit 150A may compute the orientation flag CW according to one of the following equations:

CW=(W₂₃==W₁₃)!=(m₂₃>m₁₃), (5)

CW=(W₂₃==W₁₃)!=(m₂₃<=m₁₃). (6)

The symbol “!=” denotes the NOT EQUAL operator. The symbol “==” denotes the EQUAL operator. The symbol “<=” denotes the LESS THAN OR EQUAL operator. Rendering unit 150A may use equation (5) to determine the orientation flag CW in those special cases which are denoted by the “>” symbol. Rendering unit 150A may use equation (6) to determine the orientation flag CW in those special cases which are denoted by the “<=” symbol. Equation (5) specifies that the orientation flag CW equals one (corresponding to clockwise orientation) only if (a) the octants defined by the displacement vectors d₁₃ and d₂₃ are the same and (b) the slope m₂₃ is not greater than slope m₁₃, or, (c) the octants defined by the displacement vectors are different and (d) the slope m₂₃ is greater than slope m₁₃. Equation (6) specifies that the orientation flag CW equals one (corresponding to clockwise orientation) only if (e) the octants defined by the displacement vectors d₁₃ and d₂₃ are the same and (f) the slope m₂₃ is greater than slope m₂₃, or, (g) the octants defined by the displacement vectors are different and (h) the slope m₂₃ is less than or equal to slope m₁₃.

If the slopes m₁₃ and m₂₃ are the same, then the triangle is degenerate (i.e., with no interior area). Degenerate triangles can be explicitly tested for and culled, or, with proper numerical care, they may be forwarded to succeeding rendering stages as they will cause no samples to render. One special case arises when a triangle splits the view plane. However, this case may be detected earlier in the rendering pipeline (e.g., when front plane and back plane clipping are performed).

Note that this method of orientation lookup only uses one additional comparison (i.e., of the slope m₁₃ of edge13 to the slope m₂₃ of edge23) beyond factors already computed.

In most cases, only one side of a triangle is rendered. Thus, if the orientation of a triangle determined by the analysis above is the one to be rejected, then the triangle can be culled.

Interpolating Sample Ordinate Values

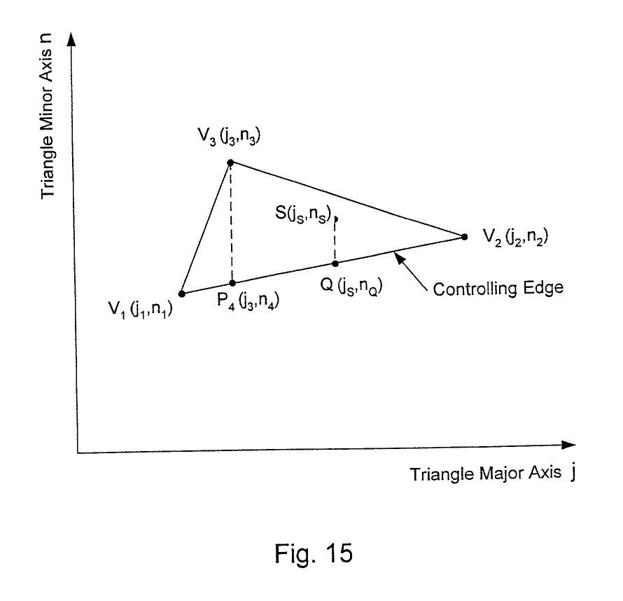

As described above in connection with step 224 of FIG. 13B, rendering unit 150A may compute ordinate values (e.g. red, green, blue, alpha, Z, etc.) for samples which have been identified (in step 220) as residing inside the given triangle. FIG. 15 illustrates one embodiment of the ordinate value computation for a given triangle. Vertices V₁, V₂ and V₃ of the triangle may be stored in a RAM buffer, e.g., in memory 156. Each vertex Vₖ=(xₖ, yₖ) has an associated ordinate vector Hₖ containing ordinate values for the vertex Vₖ. In one embodiment, each ordinate vector Hₖ comprises red, green, blue, alpha and Z values for vertex Vₖ, i.e.

H₁=(R₁,G₁,B₁,A₁,Z₁, . . . ),

H₂=(R₂,G₂,B₂,A₂,Z₂, . . . ),

H₃=(R₃,G₃,B₃,A₃,Z₃, . . . ).

Each ordinate vector Hₖ may also include texture values. The ordinate vectors H₁, H₂ and H₃ may also be stored in the RAM buffer. Rendering unit 150A may compute a vector H_{S} of ordinate values for each sample S inside the given triangle based on the coordinates (x_{S}, y_{S}) of the sample, the coordinates of vertices V₁, V₂ and V₃, and the ordinate vectors H₁, H₂ and H₃. Rendering unit 150A may compute ordinate vector H_{S} for a sample only if the sample is inside the triangle as indicated by the sample VALID flag.

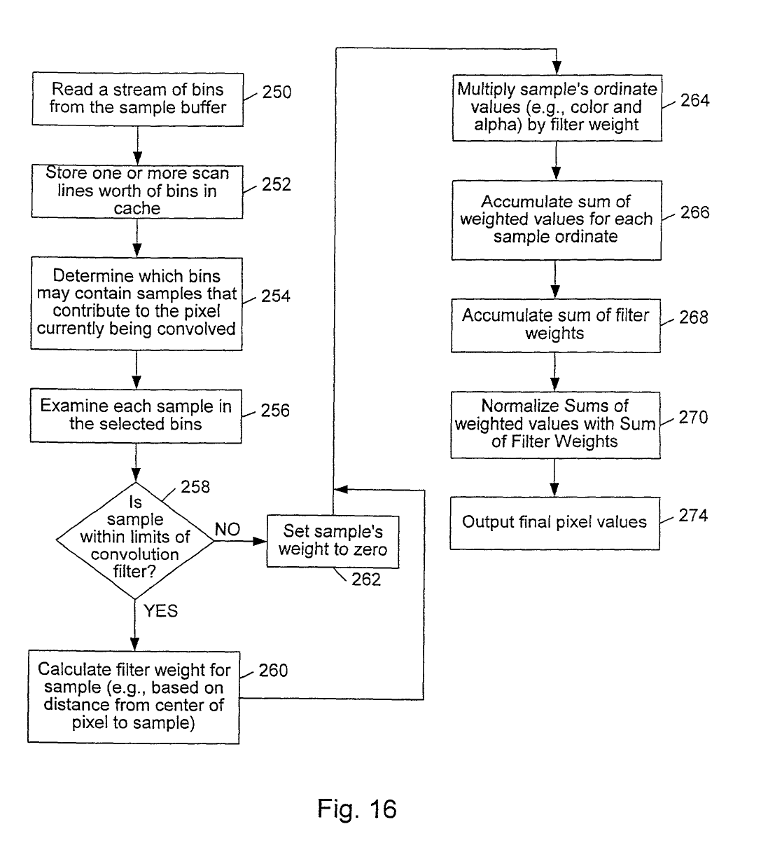

FIG. 16—Generating Output Pixels Values from Sample Values

FIG. 16 is a flowchart of one embodiment of a method for selecting and filtering samples stored in super-sampled sample buffer 162 to generate output pixel values. In step 250, a stream of memory bins are read from the super-sampled sample buffer 162. In step 252, these memory bins may be stored in one or more of bin caches 176 to allow the sample-to-pixel calculation units 170 easy access to samples (i.e. sample positions and their corresponding ordinate values) during the convolution operation. In step 254, the memory bins are examined to determine which of the memory bins may contain samples that contribute to the output pixel value currently being generated. The support (i.e. footprint) of the filter kernel 400 (see FIG. 12A) intersects a collection of spatial bins. The memory bins corresponding to these samples may contain sample values that contribute to the current output pixel.

Each sample in the selected bins (i.e. bins that have been identified in step 254) is then individually examined to determine if the sample does indeed contribute samples to the support of filter kernel 400 (as indicated in steps 256-258). This determnination may be based upon the distance from the sample to the center of the output pixel being generated.

In one embodiment, the sample-to-pixel calculation units 170 may be configured to calculate this sample distance (i.e., the distance of the sample from the filter center) and then use it to index into a table storing filter weight values (as indicated in step 260). In another embodiment, however, the potentially expensive calculation for determining the distance from the center of the pixel to the sample (which typically involves a square root function) may be avoided by using distance squared to index into the table of filter weights. In one embodiment, this squared-distance indexing scheme may be facilitated by using a floating point format for the distance (e.g., four or five bits of mantissa and three bits of exponent), thereby allowing much of the accuracy to be maintained while compensating for the increased range in values. The table of filter weights may be stored in ROM and/or RAM. Filter tables implemented in RAM may, in some embodiments, allow the graphics system to vary the filter coefficients on a per-frame or per-session basis. For example, the filter coefficients may be varied to compensate for known shortcomings of a display and/or projection device or for the user's personal preferences. The graphics system can also vary the filter coefficients on a screen area basis within a frame, or on a per-output pixel basis. In another alternative embodiment, graphics board GB may include specialized hardware (e.g., multipliers and adders) to calculate the desired filter weights for each sample. The filter weight for samples outside the limits of the convolution filter may simply be multiplied by a filter weight of zero (step 262), or they may be removed from the convolution-sum calculation entirely.

In one alternative embodiment, the filter kernel may not be expressible as a function of distance with respect to the filter center. For example, a pyramidal tent filter is not expressible as a function of distance from the filter center. Thus, filter weights may be tabulated (or computed) in terms of X and Y sample-displacements with respect to the filter center.

Once the filter weight for a sample has been determined, the ordinate values (e.g. red, green, blue, alpha, etc.) for the sample may then be multiplied by the filter weight (as indicated in step 264). Each of the weighted ordinate values may then be added to a corresponding cumulative sum—one cumulative sum for each ordinate—as indicated in step 266. The filter weight itself may be added to a cumulative sum of filter weights (as indicated in step 268). After all samples residing in the support of the filter have been processed, the cumulative sums of the weighted ordinate values may be divided by the cumulative sum of filter weights (as indicated in step 270). It is noted that the number of samples which fall within the filter support may vary as the filter center moves within the 2-D viewport. The normalization step 270 compensates for the variable gain which is introduced by this nonuniformity in the number of included samples, and thus, prevents the computed pixel values from appearing too bright or too dark due to the sample number variation. Finally, the normalized output pixels may be output for gamma correction, digital-to-analog conversion (if necessary), and eventual display (step 274).

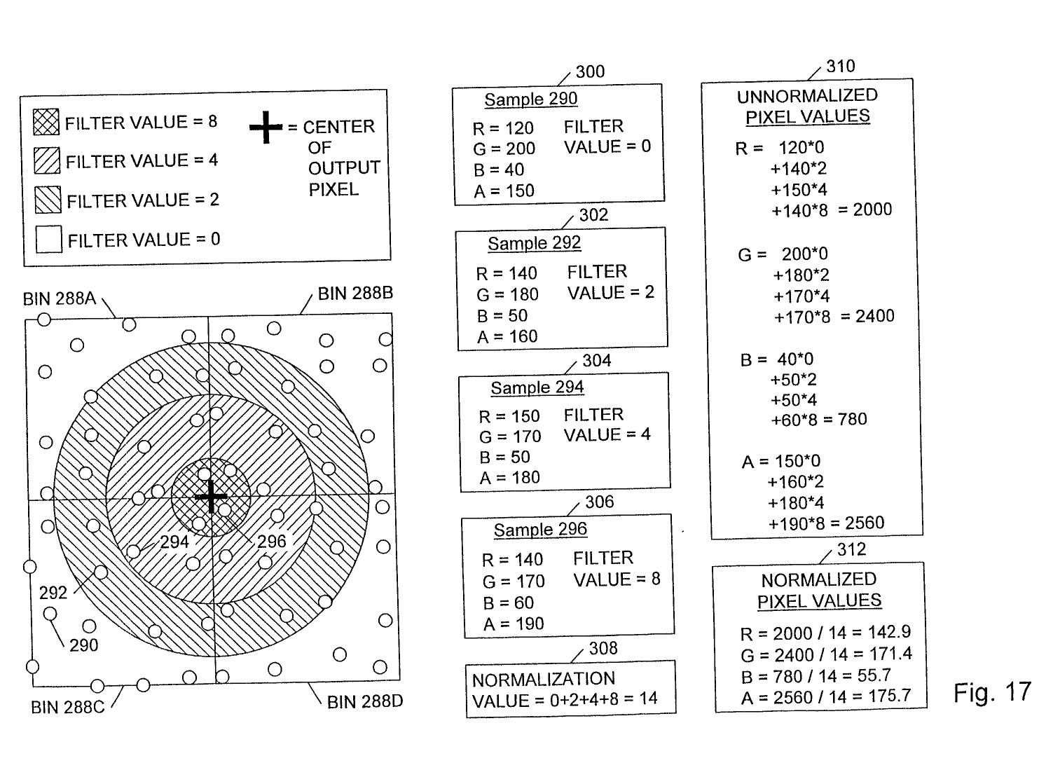

FIG. 17—Example Output Pixel Convolution

FIG. 17 illustrates a simplified example of an output pixel convolution with a filter kernel which is radially symmetric and piecewise constant. As the figure shows, four bins 288A-D contain samples that may possibly contribute to the output pixel convolution. In this example, the center of the output pixel is located at the shared corner of bins 288A-288D. Each bin comprises sixteen samples, and an array of four bins (2×2) is filtered to generate the ordinate values (e.g. red, green, blue, alpha, etc.) for the output pixel. Since the filter kernel is radially symmetric, the distance of each sample from the pixel center determines the filter value which will be applied to the sample. For example, sample 296 is relatively close to the pixel center, and thus falls within the region of the filter having a filter value of 8. Similarly, samples 294 and 292 fall within the regions of the filter having filter values of 4 and 2, respectively. Sample 290, however, falls outside the maximum filter radius, and thus receives a filter value of 0. Thus, sample 290 will not contribute to the computed ordinate values for the output pixel. Because the filter kernel is a decreasing function of distance from the pixel center, samples close to the pixel center may contribute more to the computed ordinate values than samples farther from the pixel center. This type of filtering may be used to perform image smoothing or anti-aliasing.

Example ordinate values for samples 290-296 are illustrated in boxes 300-306. In this example, each sample comprises red, green, blue and alpha values, in addition to the sample's positional data. Block 310 illustrates the calculation of each pixel ordinate value prior to normalization. As previously noted, the filter values may be summed to obtain a normalization value 308. Normalization value 308 is used to divide out the unwanted gain arising from the non-constancy of the number of samples captured by the filter support. Block 312 illustrates the normalization process and the final normalized pixel ordinate values.

The filter presented in FIG. 17 has been chosen for descriptive purposes only and is not meant to be limiting. A wide variety of filters may be used for pixel value computations depending upon the desired filtering effect(s). It is a well known fact that the sinc filter realizes an ideal band-pass filter. However, the sinc filter takes non-zero values over the whole of the X-Y plane. Thus, various windowed approximations of the sinc filter have been developed. Some of these approximations such as the cone filter or Gaussian filter approximate only the central lobe of the sinc filter, and thus, achieve a smoothing effect on the sampled image. Better approximations such as the Mitchell-Netravali filter (including the Catmull-Rom filter as a special case) are obtained by approximating some of the negative lobes and positive lobes which surround the central positive lobe of the sinc filter. The negative lobes allow a filter to more effectively retain spatial frequencies up to the cutoff frequency and reject spatial frequencies beyond the cutoff frequency. A negative lobe is a portion of a filter where the filter values are negative. Thus, some of the samples residing in the support of a filter may be assigned negative filter values (i.e. filter weights).

A wide variety of filters may be used for the pixel value convolutions including filters such as a box filter, a tent filter, a cylinder filter, a cone filter, a Gaussian filter, a Catmull-Rom filter, a Mitchell-Netravali filter, any windowed approximation of a sinc filter, etc. Furthermore, the support of the filters used for the pixel value convolutions may be circular, elliptical, rectangular (e.g. square), triangular, hexagonal, etc.

The piecewise constant filter function shown in FIG. 17 with four constant regions is not meant to be limiting. For example, in one embodiment the convolution filter may have a large number of regions each with an assigned filter value (which may be positive, negative and/or zero). In another embodiment, the convolution filter may be a continuous function that is evaluated for each sample based on the sample's distance (or X and Y displacements) from the pixel center. Also note that floating point values may be used for increased precision.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the headings used herein are for organizational purposes only and are not meant to limit the description provided herein or the claims attached hereto.

What is claimed is:

1. A method for displaying graphical images, the method comprising:
receiving vertices defining a triangle, wherein the vertices are presented as coordinate pairs with respect to coordinate axes;
(a) filtering a collection of sample positions to determine first filtered sample positions which reside inside a first tight bounding box, wherein the first tight bounding box has sides parallel to the coordinate axes;
(b) operating on the first filtered sample positions to determine interior sample positions which reside inside the triangle;
(c) assigning sample values to the interior sample positions based on corresponding values assigned to the vertices of the triangle and the relative positions of the interior sample positions with respect to the vertices; and
(d) filtering the sample values to form a pixel value and transmitting the pixel value to a display device.

2. The method of claim 1 further comprising:
selecting a first set of candidate bins among a plurality of bins, wherein said first set of candidate bins contain the triangle; and
generating the collection of sample positions within said first set of candidate bins.

3. The method of claim 2 wherein said selecting the first set of candidate bins comprises computing a minimal box of bins surrounding said triangle.

4. The method of claim 1 wherein (b) comprises:
(b1) filtering the first filtered sample positions to determine second filtered sample positions which reside inside a second tight bounding box, wherein the second tight bounding box has sides of slope one and minus one with respect to the coordinate axes; and
(b2) filtering the second filtered sample positions with respect to the triangle edges to determine the interior sample positions which reside inside the triangle.

5. The method of claim 4, wherein each vertex of the triangle comprises a first coordinate x and a second coordinate y, the method further comprising:
generating edge parameters for the second tight bounding box by computing the maximum and minimum of the quantities (y−x) and (y+x) evaluated at the vertices of the triangle.

6. The method of claim 5, wherein (b1) comprises:
computing a first arithmetic expression (x_{S}−y_{S}+k) for a first edge of the second tight bounding box, wherein xs is a first coordinate of one of the first filtered sample positions, y_{S} is a second coordinate of said one of the first filtered sample positions, and k is one of said edge parameters corresponding to the first edge;
determining if the first arithmetic expression satisfies a first inequality condition.

7. The method of claim 6, wherein (b1) further comprises:
computing a second arithmetic expression (x_{S}+y_{S}−r) for a second edge of the second tight bounding box, and r is one of said edge parameters corresponding to the second edge;
determining if the second arithmetic expression satisfies a second inequality condition.

8. The method of claim 4, wherein (b2) comprises:
computing an edge relative coordinate displacement for each of the second filtered sample positions with respect to each of three edges of the triangle;
analyzing the signs of the edge relative coordinate displacements.

9. The method of claim 8, wherein the rendering unit is configured to analyze the signs of the edge relative coordinate displacements by determining if said signs have values equal to corresponding accept values respectively, wherein the accept values define the interior side of each edge of the triangle.

10. The method of claim 1 further comprising:
generating edge coordinates for the first tight bounding box by computing a maximum and minimum of first coordinates of said vertices, and a maximum and minimum of second coordinates of said vertices.

11. The method of claim 10 wherein (a) comprises:
comparing coordinates of each of the sample positions to the edge coordinates of the first tight bounding box.

12. A system comprising:
a rendering unit configured to:
receive vertices defining a triangle, wherein the vertices are presented as coordinate pairs with respect to coordinate axes;
(a) filter a collection of sample positions to determine first filtered sample positions which reside inside a first tight bounding box, wherein the first tight bounding box has sides parallel to the coordinate axes;
(b) operate on the first filtered sample positions to determine interior sample positions which reside inside the triangle;
(d) compute sample values at the interior sample positions based on corresponding values assigned to the vertices of the triangle and the relative position of the interior sample positions with respect to the vertices;
a filtering unit configured to filter the sample values to generate a pixel value, and further configured to transmit the pixel value to a display device.

13. The system of claim 12, wherein the rendering unit is further configured to:
select a first set of candidate bins among a plurality of bins, wherein said first set of candidate bins contain the triangle; and
generate the collection of sample positions within said first set of candidate bins.

14. The system of claim 13, wherein the rendering unit is configured to select the first set of candidate bins by computing a minimal box of bins containing said triangle.

15. The system of claim 12, wherein said rendering unit is configured to perform (b) by:
(b1) filtering the first filtered sample positions to determine second filtered sample positions which reside inside a second tight bounding box, wherein the second tight bounding box has sides of slope one and minus one with respect to the coordinate axes;
(b2) filtering the second filtered sample positions with respect to the triangle edges to determine the interior sample positions which reside inside the triangle.

16. The system of claim 15, wherein each vertex of the triangle comprises a first coordinate x and a second coordinate y, wherein the rendering unit is further configured to generate edge parameters for the second tight bounding box by computing the maximum and minimum of the quantities (y−x) and (y+x) evaluated at the vertices of the triangle.

17. The system of claim 16, wherein the rendering unit is configured to perform (b1) by:
computing a first arithmetic expression (x_{S}−y_{S}+k) for a first edge of the second tight bounding box, wherein xs is a first coordinate of one of the first filtered sample positions, y_{S} is a second coordinate of said one of the first filtered sample positions, k is one of said edge parameters corresponding to the first edge;
determining if the first arithmetic expression satisfies a first inequality condition.

18. The system of claim 17, wherein the rendering unit is further configured to perform (b1) by:
computing a second arithmetic expression (x_{S}+y_{S}−r) for a second edge of the second tight bounding box, r is one of said edge parameters corresponding to the second edge; and
determining if the second arithmetic expression satisfies a second inequality condition.

19. The system of claim 15, wherein the rendering unit is configured to perform (b2) by:
computing an edge relative coordinate displacement for each of the second filtered sample positions with respect to each of three edges of the triangle; and
analyzing the signs of the edge relative coordinate displacements.

20. The system of claim 19, wherein the rendering unit is configured to analyze the signs of the edge relative coordinate displacements by determining if said signs have values equal to corresponding accept values, wherein the accept values define the interior side of each edge of the triangle.

21. The system of claim 12, wherein the rendering unit is further configured to generate edge coordinates for the first tight bounding box by computing a maximum and minimum of first coordinates of said vertices, and a maximum and minimum of second coordinates of said vertices.

22. The system of claim 21, wherein the rendering unit is configured to perform (a) by comparing coordinates of each of the sample positions to the edge coordinates for the first tight bounding box.

23. The system of claim 12 further comprising a sample buffer coupled to the rendering unit and the filtering unit, wherein the sample buffer is configured to receive and store said sample values computed by the rendering unit, wherein the filtering unit is configured to read said sample values from the sample buffer in order to perform said filtering of said sample values.

24. A method comprising:
(a) receiving vertices defining a graphical primitive, wherein the vertices include coordinate pairs with respect to coordinate axes;
(b) performing one or more filtering operations on a collection of sample positions to determine filtered sample positions, wherein said one or more filtering operations includes filtering said sample positions with respect to a first bounding box, wherein the first bounding box has sides of slope one and minus one with respect to the coordinate axes and contains the graphical primitive.
(c) performing another filtering operation on the filtered sample positions to determine interior sample positions which reside inside the graphical primitive;
(d) computing sample values for the interior sample positions based on corresponding values assigned to the vertices of the graphical primitive and the relative locations of the interior sample positions with respect to the vertices of the graphical primitive; and
(e) filtering the sample values to form a pixel value and determining at least a portion of a video signal based on said pixel value.

25. The method of claim 24, wherein said one or more filtering operations further includes filtering said sample positions with respect to a second bounding box, wherein the second bounding box has sides parallel to the coordinate axes and contains the graphical primitive.
